(19) United States
(12) Patent Application Publication
(10) Pub. No.: US 2026/0011490 A1
(43) Pub. Date: Jan. 8, 2026

(54) MULTILAYER CERAMIC ELECTRONIC COMPONENT AND MOUNTING STRUCTURE FOR MULTILAYER CERAMIC ELECTRONIC COMPONENT

(71) Applicant: Murata Manufacturing Co., Ltd., Nagaokakyo-shi (JP)

(72) Inventor: Tomohiro SASAKI, Nagaokakyo-shi (JP)

(21) Appl. No.: 19/324,496

(22) Filed: Sep. 10, 2025

Related U.S. Application Data
(63) Continuation of application No. PCT/JP2024/010404, filed on Mar. 18, 2024.

(30) Foreign Application Priority Data
May 24, 2023 (JP) 2023-085222

(51) Int. Cl. H01G 2/14; H01G 2/06; H01G 4/005; H01G 4/12; H01G 4/232; H01G 4/248; H01G 4/30

(52) U.S. Cl. CPC H01G 2/14; H01G 2/065; H01G 4/005; H01G 4/12; H01G 4/232; H01G 4/248; H01G 4/30

(57) ABSTRACT

A multilayer ceramic electronic component includes a multilayer ceramic capacitor, and a conductor portion. The multilayer ceramic capacitor includes first- and second-end-surface external electrodes extending around to first and second main surfaces respectively from first and second end surfaces, first- and second-side-surface external electrodes respectively on first and second side surfaces. The conductor portion is electrically connected to the first- and second-end-surface external electrodes, and includes first and second connection regions respectively on a multilayer ceramic capacitor side and a first end surface side, and on a conductor portion side and a second end surface side. The first connection region and the first-end-surface external electrode are connected by a conductive adhesive. A DC resistance of the conductor portion is smaller than a DC resistance of the multilayer ceramic capacitor.

### CROSS REFERENCE TO RELATED APPLICATIONS

This application claims the benefit of priority to Japanese Patent Application No. 2023-085222, filed on May 24, 2023 and is a Continuation Application of PCT Application No. PCT/JP2024/010404 filed on Mar. 18, 2024. The entire contents of each application are hereby incorporated herein by reference.

### BACKGROUND OF THE INVENTION

### 1. Field of the Invention

The present invention relates to multilayer ceramic electronic components and mounting configurations for multilayer ceramic electronic components.

### 2. Description of the Related Art

For example, decoupling capacitors have been used to stabilize power supply voltage supplied to high-speed operating integrated circuit components (ICs). In addition, through-type three-terminal capacitors have been known as noise countermeasure components for power supply lines supplied to integrated circuit components (ICs). A through-type three-terminal capacitor generally includes a multilayer body including a first main surface and a second main surface opposed to each other, a first lateral surface and a second lateral surface opposed to each other, and a first end surface and a second end surface opposed to each other. Within the multilayer body, a plurality of first internal electrode layers and second internal electrode layers are alternately arranged in the lamination direction. The first internal electrode layers extend to the first end surface and the second end surface at both ends thereof, and the second internal electrode layers extend to the first lateral surface and the second lateral surface at both ends thereof. The first internal electrode layers are connected to a first external electrode and a second external electrode, and the second internal electrode layers are connected to a third external electrode and a fourth external electrode.

When a typical through-type three-terminal capacitor is used as a noise filter, direct current flows through the signal internal electrodes (the first internal electrode layers). However, when the capacitance is reduced, the number of the signal internal electrodes (the first internal electrode layers) decreases, resulting in increased direct current resistance, which in turn causes an increase in heat generation from the capacitor.

Therefore, as a configuration of a low-capacitance through-type three-terminal capacitor that can suppress both an increase in capacitance and an increase in direct current resistance, a configuration such as that disclosed in Japanese Unexamined Patent Application, Publication No. H9-55335 has been provided. By increasing the number of the signal internal electrodes (the first internal electrode layers) and arranging the signal internal electrodes (the first internal electrode layers) to be opposed to each other, both of the capacitance and the direct current resistance can be suppressed.

However, the configuration disclosed in Japanese Unexamined Patent Application, Publication No. H9-55335 involves the following points that need consideration. That is, there is a limit to increasing the number of signal internal electrodes (the first internal electrode layers) within a predetermined size constraint, which makes it difficult to accommodate larger current. Furthermore, it is necessary to design the internal configuration individually for each capacitance value, which limits the expandability of the product lineup.

### SUMMARY OF THE INVENTION

Example embodiments of the present invention provide multilayer ceramic electronic components each able to reduce or prevent both an increase in capacitance and an increase in direct current resistance, without requiring the internal configuration to be redesigned for each capacitance.

A multilayer ceramic electronic component according to an example embodiment of the present invention includes a multilayer ceramic capacitor and a conductor portion. The multilayer ceramic capacitor includes a multilayer body. The multilayer body includes a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to both the lamination direction and the width direction, a first end surface external electrode wrapping around from the first end surface to the first main surface and the second main surface of the multilayer body, a second end surface external electrode wrapping around from the second end surface to the first main surface and the second main surface of the multilayer body, a first lateral surface external electrode on the first lateral surface of the multilayer body, a second lateral surface external electrode on the second lateral surface of the multilayer body, and a conductor portion electrically connected to the first end surface external electrode and the second end surface external electrode. The conductor portion includes a first connection region on one of surfaces of the conductor portion opposed to each other in the lamination direction, the one of the surfaces being located on the multilayer ceramic capacitor side, the first connection region being located on a first end surface side, and a second connection region on the one of the surfaces of the conductor portion opposed to each other in the lamination direction, the one of the surfaces being located on the multilayer ceramic capacitor side, and the first connection region being located on a first end surface side. A tip of the first connection region on a center side in the length direction of the multilayer ceramic capacitor is located closer to the first end surface side than a tip of the first end surface external electrode on the center side in the length direction. The first end surface external electrode is provided on the first main surface. The first connection region is connected to the first end surface external electrode by an electrically conductive adhesive. A direct current resistance RdcA of the conductor portion is smaller than a direct current resistance RdcB of the multilayer ceramic capacitor.

A mounting configuration for a multilayer ceramic electronic component according to an example embodiment of the present invention includes a multilayer ceramic electronic component according to an example embodiment of the present invention, and a mounting board on which the multilayer ceramic electronic component is mounted. The multilayer ceramic electronic component is mounted such that the conductor portion does not face the mounting surface.

In multilayer ceramic electronic components according to example embodiments of the present invention, the direct current resistance RdcA of the conductor portion connected to the multilayer ceramic capacitor is smaller than the direct current resistance RdcB of the multilayer ceramic capacitor. With such a configuration, direct current can flow through the conductor portion, while alternating current can be diverted to the multilayer ceramic capacitor. More specifically, direct current tends to flow through a path with lower direct current resistance, thus direct current flows more easily through the conductor portion, which has lower resistance than the multilayer ceramic capacitor. On the other hand, alternating current tends to flow through a path with lower impedance, thus alternative current flows more easily through the multilayer ceramic capacitor, which has lower impedance. With such a configuration, it is possible to reduce or prevent an increase in the capacitance and an increase in the direct current resistance of the multilayer ceramic capacitor. Furthermore, it is possible to accommodate large current simply by attaching the conductor portion to an existing multilayer ceramic capacitor, without the need to newly design the internal configuration for each capacitance. With such a configuration, the expandability of a product lineup is also able to be improved.

In the multilayer ceramic electronic component according to the above-described example embodiment of the present invention, the conductor portion includes a first connection region on one of the surfaces of the conductor portion opposed to each other in the lamination direction, the surface being located on the multilayer ceramic capacitor side and on the first end surface side, and a second connection region on one of the surfaces of the conductor portion opposed to each other in the lamination direction, the surface being located on the multilayer ceramic capacitor side and on the second end surface side. A tip of the first connection region on a center side in the length direction of the multilayer ceramic capacitor is located closer to the first end surface side than a tip of the first end surface external electrode on a center side in the length direction, the first end surface external electrode being provided on the first main surface. The first connection region is connected to the first end surface external electrode by an electrically conductive adhesive. With such a configuration, when connecting the conductor portion and the multilayer ceramic capacitor, e.g., by reflowing an electrically conductive adhesive such as solder, stress generated at the tip on the center side in the length direction of the end surface external electrode of the multilayer body can be reduced. As a result, it is possible to reduce the occurrence of cracks during the reflow process.

Furthermore, in the mounting configuration for the multilayer ceramic electronic component according to the above-described example embodiment of the present invention, the multilayer ceramic electronic component is mounted such that the conductor portion does not face the mounting surface. By mounting the multilayer ceramic electronic component in this manner, the distance between the multilayer ceramic capacitor and the mounting board is not unnecessarily increased, and the advantageous effect of low ESL (Equivalent Series Inductance) is readily obtained. In addition, the multilayer ceramic electronic component can be mounted without affecting the mounting operation on the mounting board.

According to example embodiments of the present invention, multilayer ceramic electronic components and mounting configurations for multilayer ceramic electronic components each reduce or prevent an increase in capacitance and an increase in direct current resistance, while eliminating the need to design the internal configuration for each capacitance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing a multilayer ceramic electronic component according to an example embodiment of the present invention.

FIG. 2 is a front view showing a multilayer ceramic electronic component according to an example embodiment of the present invention.

FIG. 3 is a perspective view showing a multilayer ceramic capacitor according to an example embodiment of the present invention.

FIG. 4 is a front view showing a multilayer ceramic capacitor according to an example embodiment of the present invention.

FIG. 5 is a plan view showing a multilayer ceramic capacitor according to an example embodiment of the present invention.

FIG. 6 is a cross-sectional view taken along the line VI-VI of FIG. 3.

FIG. 7 is a cross-sectional view taken along the line VII-VII of FIG. 3.

FIG. 8 is a cross-sectional view taken along the line VIII-VIII of FIG. 6.

FIG. 9 is a cross-sectional view taken along the line IX-IX of FIG. 6.

FIG. 10 is a cross-sectional view showing an example of a conductor portion according to an example embodiment of the present invention.

FIG. 11A is a cross-sectional view showing a first modified example of a conductor portion according to an example embodiment of the present invention.

FIG. 11B is a cross-sectional view showing a second modified example of a conductor portion according to an example embodiment of the present invention.

FIG. 11C is a cross-sectional view showing a third modified example of a conductor portion according to an example embodiment of the present invention.

FIG. 11D is a cross-sectional view showing a fourth modified example of a conductor portion according to an example embodiment of the present invention.

FIG. 12 is a cross-sectional view in the lamination direction, showing a mounting configuration of a multilayer ceramic electronic component according to an example embodiment of the present invention.

FIG. 13 is a cross-sectional view in the width direction, showing a mounting configuration of a multilayer ceramic electronic component according to an example embodiment of the present invention.

FIG. 14 is a cross-sectional view in the lamination direction, showing another mounting configuration of a multilayer ceramic electronic component according to an example embodiment of the present invention.

FIG. 15 is a cross-sectional view in the width direction, showing another mounting configuration of a multilayer ceramic electronic component according to an example embodiment of the present invention.

FIG. 16 is a cross-sectional view showing a first modified example of a multilayer ceramic capacitor according to an example embodiment of the present invention, corresponding to the cross-sectional view of FIG. 6.

FIG. 17 is a cross-sectional view showing a first modified example of a multilayer ceramic capacitor according to an example embodiment of the present invention, corresponding to the cross-sectional view of FIG. 7.

FIG. 18 is a cross-sectional view taken along the line XVIII-XVIII of FIG. 16.

FIG. 19 is a cross-sectional view taken along the line XIX-XIX of FIG. 16.

FIG. 20 is a cross-sectional view showing a second modified example of a multilayer ceramic capacitor according to an example embodiment of the present invention, corresponding to the cross-sectional view of FIG. 6.

FIG. 21 is a cross-sectional view showing a second modified example of a multilayer ceramic capacitor according to an example embodiment of the present invention, corresponding to the cross-sectional view of FIG. 7.

### DETAILED DESCRIPTION OF THE EXAMPLE EMBODIMENTS

Example embodiments of the present invention will be described in detail below with reference to the drawings.

### 1. MULTILAYER CERAMIC ELECTRONIC COMPONENT

A multilayer ceramic electronic component 100 according to example embodiments of the present invention will be described.

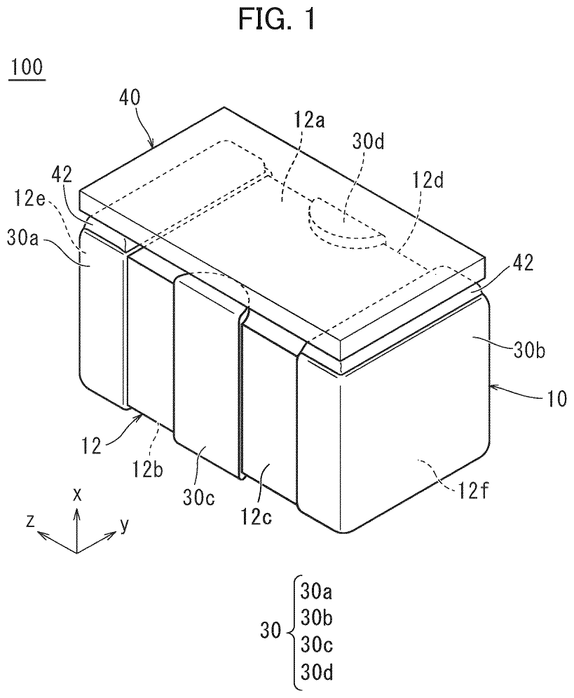

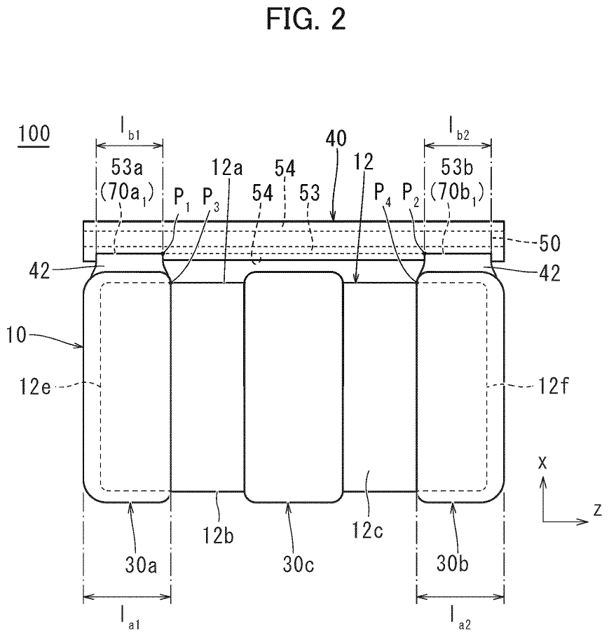

FIG. 1 is an external perspective view showing a multilayer ceramic electronic component according to an example embodiment of the present invention. FIG. 2 is a front view showing the multilayer ceramic electronic component according to the present example embodiment.

As shown in FIGS. 1 and 2, the multilayer ceramic electronic component 100 includes a multilayer ceramic capacitor 10 and a conductor portion 40.

### (a) Multilayer Ceramic Capacitor

The multilayer ceramic capacitor 10 according to the present example embodiment will be described.

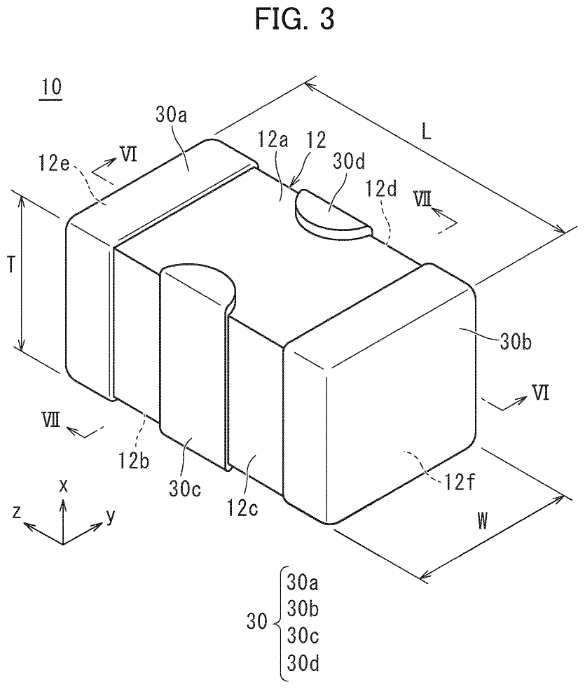

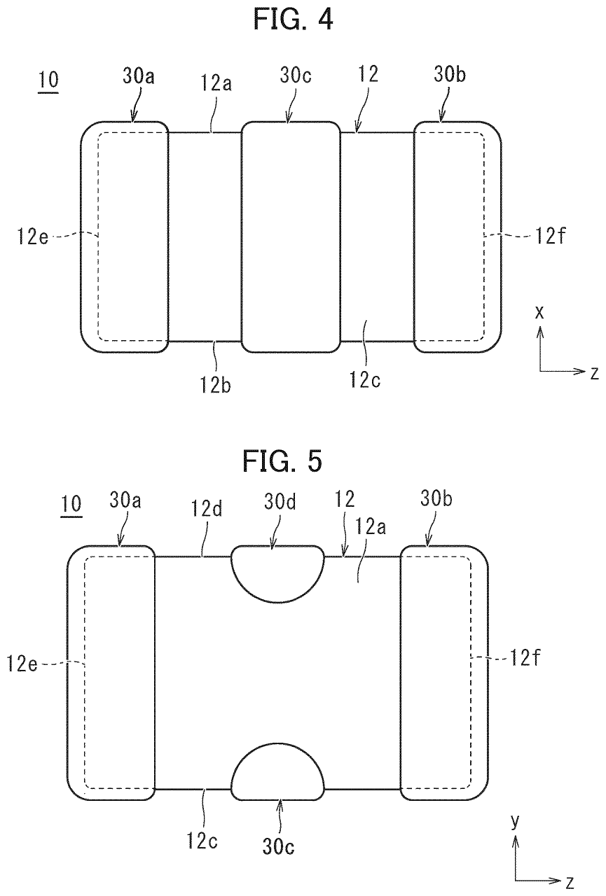

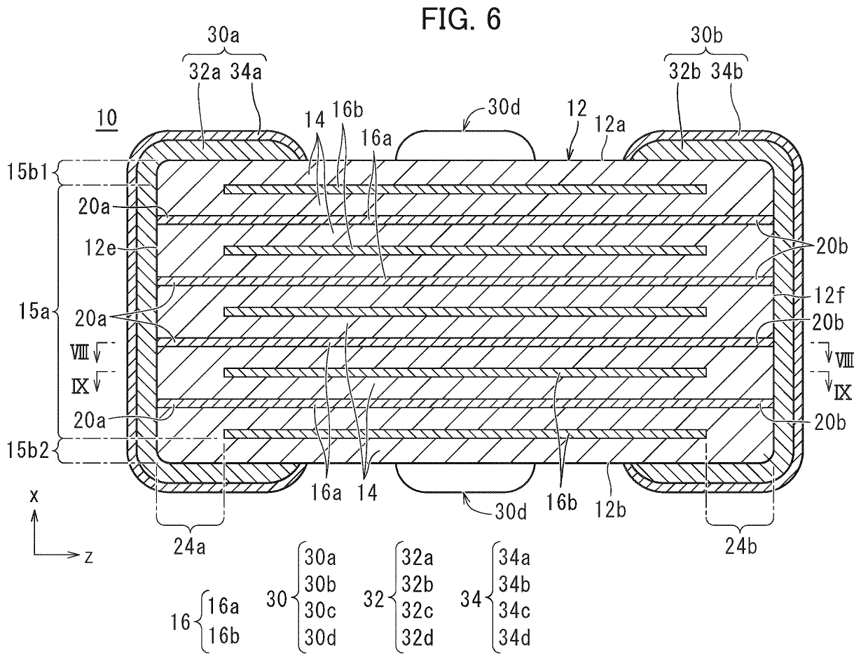

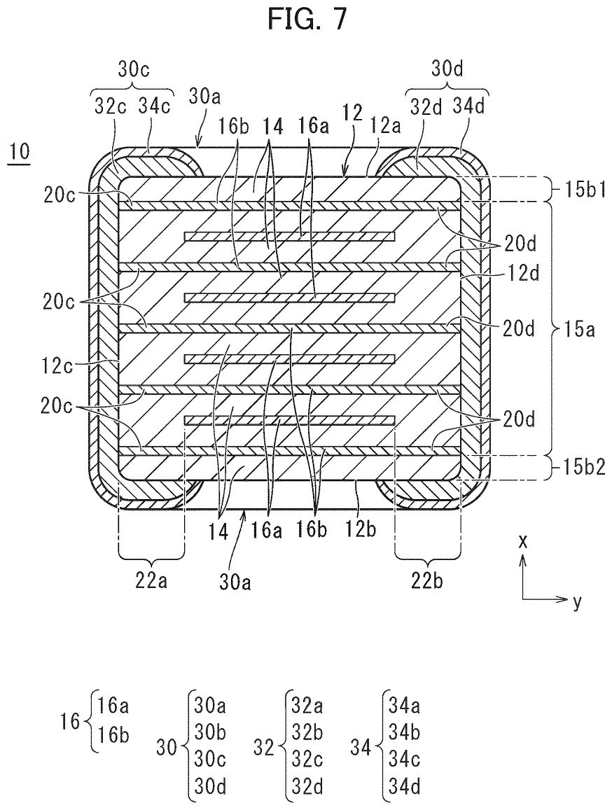

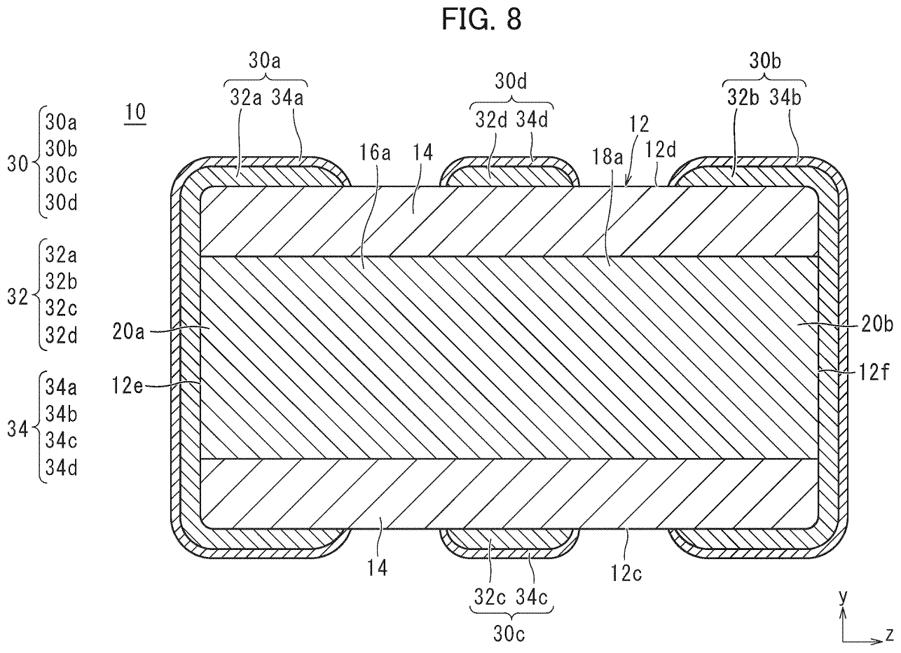

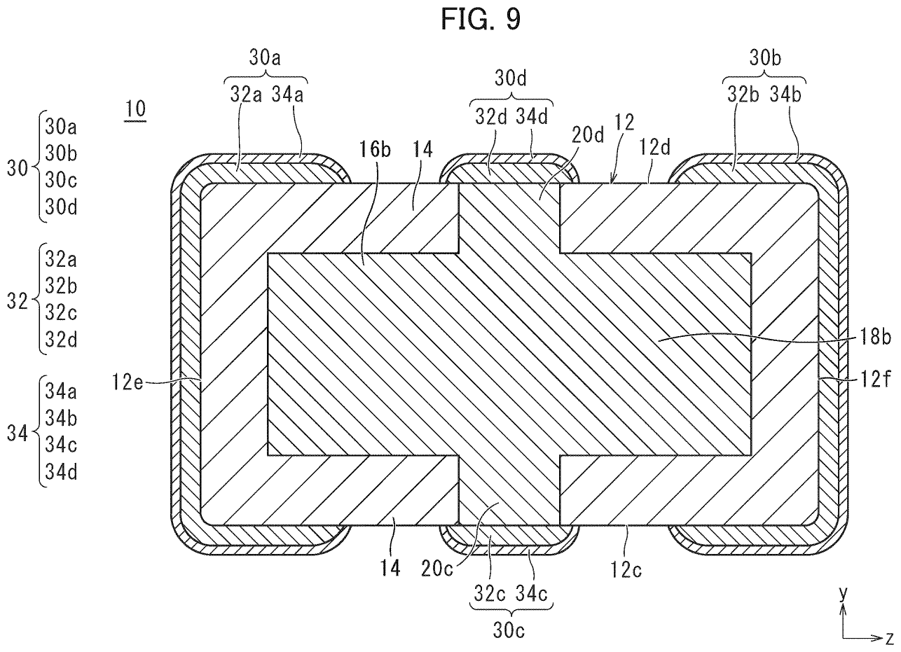

FIG. 3 is a perspective view showing the multilayer ceramic capacitor according to the present example embodiment. FIG. 4 is a front view showing the multilayer ceramic capacitor according to the present example embodiment. FIG. 5 is a plan view showing the multilayer ceramic capacitor according to the present example embodiment. FIG. 6 is a cross-sectional view taken along the line VI-VI of FIG. 3. FIG. 7 is a cross-sectional view taken along the line VII-VII of FIG. 3. FIG. 8 is a cross-sectional view taken along the line VIII-VIII of FIG. 6. FIG. 9 is a cross-sectional view taken along the line IX-IX of FIG. 6.

The multilayer ceramic capacitor 10 includes a multilayer body 12 and external electrodes 30. Each configuration of the multilayer body 12 and the external electrodes 30 will be described.

### Multilayer Body

The multilayer body 12 includes a plurality of dielectric layers 14 that are laminated. Further, the multilayer body 12 includes a first main surface 12a and a second main surface 12b on opposite sides in the lamination direction x, a first lateral surface 12c and a second lateral surface 12d on opposite sides in a width direction y orthogonal or substantially orthogonal to the lamination direction x, and a first end surface 12e and a second end surface 12f on opposite sides in a length direction z orthogonal or substantially orthogonal to both the lamination direction x and the width direction y. The multilayer body 12 is in a rectangular or substantially rectangular parallelepiped shape. The corner portions and the ridge portions of the multilayer body 12 are rounded. The corner portions refer to portions where three adjacent surfaces of the multilayer body 12 meet, and the ridge portions refer to portions where two adjacent surfaces of the multilayer body 12 meet. Irregularities or the like may be provided on a portion or the entirety of the first main surface 12a and the second main surface 12b, the first lateral surface 12c and the second lateral surface 12d, and the first end surface 12e and the second end surface 12f.

As shown in FIGS. 3 to 9, the multilayer body 12 includes an inner layer portion 15a in which a plurality of internal electrode layers 16 are alternately arranged with dielectric layers 14 interposed therebetween, a first outer layer portion 15b1 located on the first main surface 12a side and including a plurality of dielectric layers 14 positioned between the first main surface 12a and the outermost surface of the inner layer portion 15a on the first main surface 12a side, and a second outer layer portion 15b2 located on the second main surface 12b side and including a plurality of dielectric layers 14 positioned between the second main surface 12b and the outermost surface of the inner layer portion 15a on the second main surface 12b side.

Here, the plurality of dielectric layers 14 for the inner layers of the inner layer portion 15a are interposed between a first internal electrode layer 16a and a second internal electrode layer 16b, which will be described later.

The number of dielectric layers 14 to be laminated is not particularly limited but is, for example, preferably between 10 and 1000 layers inclusive, including the first outer layer portion 15b1 and the second outer layer portion 15b2. The thickness of the dielectric layer 14 is, for example, preferably between about 0.5 μm and about 15 μm inclusive.

The dielectric layer 14 can be made of a dielectric material, for example, a ceramic material. As such a dielectric material, for example, it is possible to use a dielectric ceramic including components such as BaTiO₃, CaTiO₃, SrTiO₃, or CaZrO₃. When a dielectric material including the above components as a main component is used, for example, subcomponents such as Mn compounds, Fe compounds, Cr compounds, Co compounds, or Ni compounds may be added in smaller amounts than the main component, depending on the desired characteristics of the multilayer body 12.

The dielectric layer 14 may include a plurality of crystal grains including, for example, a perovskite compound including BaTiO₃ as a basic configuration. The grain size of the crystal grains is appropriately designed depending on the thickness of the dielectric layer 14. In the present example embodiment, since thinner dielectric layers 14 result in higher capacitance of the capacitor, the crystal particle size is, for example, preferably about 1 μm or less.

Further, the dielectric layers 14 in the outer layers of the first outer layer portion 15b1 and the second outer layer portion 15b2 are made of the same dielectric ceramic material as the dielectric layers 14 of the inner layer portion 15a. The dielectric layers 14 of the first outer layer portion 15b1 and the second outer layer portion 15b2 may be made of materials different from those of the dielectric layers 14 of the inner layer portion 15a. Each of the dielectric layers 14 of the first outer layer portion 15b1 and the second outer layer portion 15b2 may include a multilayer configuration or a single-layer configuration. In the case where the dielectric layers 14 of the first outer layer portion 15b1 and the second outer layer portion 15b2 each include a multilayer configuration, it is preferable that the portions of the dielectric layers 14 of the first outer layer portion 15b1 and the second outer layer portion 15b2 located closest to the first internal electrode layer 16a and the second internal electrode layer 16b include a greater amount of silicon (Si) segregation than those located closest to the internal electrode layers. With such a configuration, it is possible to improve the flexural strength in the lamination direction x of the multilayer ceramic capacitor 10.

The multilayer body 12 includes side portions (hereinafter referred to as “W-gaps”) 22a and 22b located between the first internal electrode layer 16a and the first lateral surface 12c, and between the first internal electrode layer 16a and the second lateral surface 12d.

The multilayer body 12 also includes end portions (hereinafter referred to as “L-gaps”) 24a and 24b located between the second internal electrode layer 16b and the first end surface 12e, and between the second internal electrode layer 16b and the second end surface 12f.

### Internal Electrode Layers

As shown in FIGS. 3 to 9, the internal electrode layers 16 include a first internal electrode layer 16a exposed at the first end surface 12e and the second end surface 12f, and a second internal electrode layer 16b exposed at the first lateral surface 12c and the second lateral surface 12d.

The first internal electrode layer 16a includes a first counter electrode portion 18a opposed to the second internal electrode layer 16b, a first extension electrode portion 20a located at one end side of the first internal electrode layer 16a and extending from the first counter electrode portion 18a to the first end surface 12e of the multilayer body 12, and a second extension electrode portion 20b located at one end side of the first internal electrode layer 16a and extending from the first counter electrode portion 18a to the second end surface 12f of the multilayer body 12.

The second internal electrode layer 16b includes a second counter electrode portion 18b opposed to the first internal electrode layer 16a, a third extension electrode portion 20c located at one end side of the second internal electrode layer 16b and extending from the second counter electrode portion 18b to the first lateral surface 12c of the multilayer body 12, and a fourth extension electrode portion 20d located at one end side of the second internal electrode layer 16b and extending from the second counter electrode portion 18b to the second lateral surface 12d of the multilayer body 12.

The shape of the first counter electrode portion 18a of the first internal electrode layer 16a is not particularly limited, but is preferably rectangular or substantially rectangular in the plan view. However, the corner portions in the plan view may be rounded or may be provided obliquely (in a tapered shape). A tapered shape in the plan view with an inclination toward one direction may also be used.

The shape of the second counter electrode portion 18b of the second internal electrode layer 16b is not particularly limited, but is preferably rectangular or substantially rectangular in the plan view. However, the corner portions in the plan view may be rounded or may be provided obliquely (in a tapered shape). A tapered shape in the plan view with an inclination toward one direction may also be used.

The shapes of the first extension electrode portion 20a and the second extension electrode portion 20b of the first internal electrode layer 16a are not particularly limited, but are preferably rectangular or substantially rectangular in the plan view. However, the corner portions in the plan view may be rounded or may be provided obliquely (in a tapered shape). A tapered shape in the plan view with an inclination toward one direction may also be used.

The shapes of the third extension electrode portion 20c and the fourth extension electrode portion 20d of the second internal electrode layer 16b are not particularly limited, but are preferably rectangular or substantially rectangular in the plan view. However, the corner portions in the plan view may be rounded or may be provided obliquely (in a tapered shape). A tapered shape in the plan view with an inclination toward one direction may also be used.

The width of the first counter electrode portion 18a of the first internal electrode layer 16a and the width of the first extension electrode portion 20a and the second extension electrode portion 20b of the first internal electrode layer 16a may be the same or substantially the same, or one may be narrower than the other.

The width of the second counter electrode portion 18b of the second internal electrode layer 16b and the width of the third extension electrode portion 20c and the fourth extension electrode portion 20d of the second internal electrode layer 16b may be the same or substantially the same, or one may be formed narrower than the other.

In the present example embodiment, the widths of the third extension electrode portion 20c and the fourth extension electrode portion 20d of the second internal electrode layer 16b in the length direction z are narrower than the widths of the second counter electrode portion 18b of the second internal electrode layer 16b in the length direction z.

Although the thickness of the first internal electrode layer 16a is preferably uniform, the edge portion of the first internal electrode layer 16a may be thicker than the central portion. When the thickness of the first internal electrode layer 16a is increased, coverage is improved. Therefore, the current path becomes shorter, and the ESL characteristics improve. The edge portion of the first internal electrode layer 16a may also be thinner than the central portion. A thinner thickness reduces or prevents the step difference caused by the thickness of the first internal electrode layer 16a, thus reducing or preventing structural defects.

The first internal electrode layer 16a and the second internal electrode layer 16b may be made of a suitable conductive material including, for example, at least one of Ni, Cu, Ag, Pd, or Au, or alloys such as Ag—Pd alloy, but are not limited thereto.

In the present example embodiment, the first counter electrode portion 18a of the first internal electrode layer 16a and the second counter electrode portion 18b of the second internal electrode layer 16b are opposed to each other with the dielectric layer 14 interposed therebetween, thus generating a capacitance and providing capacitor characteristics.

The thickness of each of the first internal electrode layer 16a and the second internal electrode layer 16b is, for example, preferably between about 0.5 μm and about 1.5 μm inclusive. The number of laminated layers of the first internal electrode layer 16a and the second internal electrode layer 16b is appropriately changed depending on the size or the like. By increasing the number of the first internal electrode layers 16a, it is possible to reduce or prevent an increase in direct current resistance. The total number of the first internal electrode layers 16a and the second internal electrode layers 16b is, for example, preferably between 10 and 1000 layers inclusive.

The first extension electrode portion 20a and the second extension electrode portion 20b of the first internal electrode layer 16a may be curved. The third extension electrode portion 20c and the fourth extension electrode portion 20d of the second internal electrode layer 16b may be curved. In this case, the extension electrode portions may curve toward either the first main surface 12a or the second main surface 12b. In such a case, by arranging the curved surface as the mounting surface, the current path can be shortened.

Among the first internal electrode layers 16a extending to the first end surface 12e and the second end surface 12f, the distance between the first internal electrode layer 16a located closest to the first main surface 12a and the first internal electrode layer 16a located closest to the second main surface 12b may be shorter than the distance between the first counter electrode portion 18a of the first internal electrode layer 16a located closest to the first main surface 12a and the first counter electrode portion 18a of the first internal electrode layer 16a located closest to the second main surface 12b.

Among the second internal electrode layers 16b extending to the first lateral surface 12c and the second lateral surface 12d, the distance between the second internal electrode layer 16b located closest to the first main surface 12a and the second internal electrode layer 16b located closest to the second main surface 12b may be shorter than the distance between the second counter electrode portion 18b of the second internal electrode layer 16b located closest to the first main surface 12a and the second counter electrode portion 18b of the second internal electrode layer 16b located closest to the second main surface 12b.

In a case where the capacitor includes a high capacitance, the area of the internal electrode layers 16 is increased. Therefore, the LW surface coverage of the internal electrode layers 16 is, for example, preferably about 90% or more. Here, the LW surface coverage of the internal electrode layer 16 is defined as the ratio obtained by subtracting the area of voids from the area inside the edge of the internal electrode layer 16 as viewed from the LW surface of the multilayer body 12. Although a higher LW surface coverage of the internal electrode layer 16 results in a higher capacitance of the capacitor, even with a lower coverage, since the dielectric layers 14 are joined through the voids, the interlayer bonding strength becomes high and interlayer delamination is less likely to occur.

### External Electrodes

The external electrodes 30 include a first end surface external electrode 30a, a second end surface external electrode 30b, a first lateral surface external electrode 30c, and a second lateral surface external electrode 30d.

The first end surface external electrode 30a is connected to the first internal electrode layer 16a and is provided on the first end surface 12e. The first end surface external electrode 30a wraps around a portion of the first main surface 12a and a portion of the second main surface 12b. The first end surface external electrode 30a preferably wraps slightly around from the first end surface 12e to a portion of the first lateral surface 12c and a portion of the second lateral surface 12d.

The second end surface external electrode 30b is connected to the first internal electrode layer 16a and is provided on the second end surface 12f. The second end surface external electrode 30b wraps around a portion of the first main surface 12a and a portion of the second main surface 12b. The second end surface external electrode 30b preferably provided wraps slightly around from the second end surface 12f to a portion of the first lateral surface 12c and a portion of the second lateral surface 12d.

On the first main surface 12a, the thickness of each of the end surface external electrodes 30a and 30b in the lamination direction x is, for example, preferably between about 5 μm and about 15 μm inclusive. The thickness of each of the end surface external electrodes 30a and 30b is defined by the total thickness of a base electrode layer 32 and a plated layer 34, which will be described later.

The thickness of each of the end surface external electrodes 30a and 30b in the lamination direction x is measured by, for example, the following method. Specifically, the multilayer body 12 is polished about halfway through the width direction y thereof to expose a surface in the length direction z×lamination direction x (LT surface). On the cross-section in the length direction z×lamination direction x (LT surface) thus obtained by polishing, the end surface external electrodes 30a and 30b provided on the first main surface 12a are observed using a digital microscope (KEYENCE Corporation, model: VHX-8000) at about 1500× magnification. In this case, the thickest portions of the end surface external electrodes 30a and 30b on the first main surface 12a are defined as the respective thicknesses.

On the first main surface 12a, the dimension la1 of the first end surface external electrode 30a in the length direction z, and the dimension la2 of the second end surface external electrode 30b in the length direction z, are, for example, preferably between about 100 μm and about 450 μm inclusive.

The dimension la1 of the first end surface external electrode 30a in the length direction z is defined as the distance in the length direction z from the surface of the first end surface external electrode 30a located on the first end surface 12e to the tip of the first end surface external electrode 30a located on the surface of the first main surface 12a. The length la2 of the second end surface external electrode 30b in the length direction z is defined as the distance in the length direction z from the surface of the second end surface external electrode 30b located on the second end surface 12f to the tip of the second end surface external electrode 30b located on the surface of the first main surface 12a.

The dimension la1 of the first end surface external electrode 30a in the length direction z, and the dimension la2 of the second end surface external electrode 30b in the length direction z, are measured by, for example, the following method. That is, visually, the distance from the surface of the first end surface external electrode 30a located on the first end surface 12e to the tip of the first end surface external electrode 30a located on the surface of the first main surface 12a, and the distance from the surface of the second end surface external electrode 30b located on the second end surface 12f to the tip of the second end surface external electrode 30b located on the surface of the first main surface 12b, are observed using a digital microscope (KEYENCE Corporation, model: VHX-8000) at about 200× magnification.

The first lateral surface external electrode 30c is connected to the second internal electrode layer 16b and is provided on the first lateral surface 12c. The first lateral surface external electrode 30c is preferably provided on a portion of the first main surface 12a and a portion of the second main surface 12b. The first lateral surface external electrode 30c may be continuously provided from the first lateral surface 12c to either the first main surface 12a or the second main surface 12b.

The second lateral surface external electrode 30d is connected to the second internal electrode layer 16b and is provided on the second lateral surface 12d. The second lateral surface external electrode 30d is preferably provided on a portion of the first main surface 12a and a portion of the second main surface 12b. The second lateral surface external electrode 30d may be continuously provided from the second lateral surface 12d to either the first main surface 12a or the second main surface 12b.

The first lateral surface external electrode 30c and the second lateral surface external electrode 30d may be directly joined.

The first end surface external electrode 30a includes a first end surface base electrode layer 32a, which includes an electrically conductive metal and is provided on the multilayer body 12, and a first end surface plated layer 34a covering the first end surface base electrode layer 32a. The second end surface external electrode 30b includes a second end surface base electrode layer 32b, which includes an electrically conductive metal and is provided on the multilayer body 12, and a second end surface plated layer 34b covering the second end surface base electrode layer 32b. The first lateral surface external electrode 30c includes a first lateral surface base electrode layer 32c, which includes an electrically conductive metal and is provided on the multilayer body 12, and a first lateral surface plated layer 34c covering the first lateral surface base electrode layer 32c. The second lateral surface external electrode 30d includes a second lateral surface base electrode layer 32d, which includes an electrically conductive metal and is provided on the multilayer body 12, and a second lateral surface plated layer 34d covering the second lateral surface base electrode layer 32d.

The base electrode layers 32 include the first end surface base electrode layer 32a, the second end surface base electrode layer 32b, the first lateral surface base electrode layer 32c, and the second lateral surface base electrode layer 32d. Each of the first end surface base electrode layer 32a, the second end surface base electrode layer 32b, the first lateral surface base electrode layer 32c, and the second lateral surface base electrode layer 32d includes, for example, at least one of a fired layer, an electrically conductive resin layer, or a thin film layer.

The fired layer includes a glass component and a metal. The fired layer may include a plurality of layers.

The glass component of the fired layer includes, for example, at least one of B, Si, Ba, Mg, Al, or Li.

The metal of the fired layer includes, for example, at least one of Cu, Ni, Ag, Pd, Ag—Pd alloy, or Au.

The fired layer is formed by applying an electrically conductive paste including glass and metal to the multilayer body 12 and firing. The fired layer may be co-fired with the internal electrode layer 16 or fired after firing the internal electrode layer 16.

In a case where the fired layer is provided as the first end surface base electrode layer 32a and the second end surface base electrode layer 32b, the thickness of the fired layer in the central portion in the lamination direction x of the first end surface base electrode layer 32a and the second end surface base electrode layer 32b located on the first end surface 12e and the second end surface 12f is, for example, preferably between about 20 μm and about 50 μm inclusive.

In a case where the fired layer is provided as the first end surface base electrode layer 32a and the second end surface base electrode layer 32b on the first main surface 12a and the second main surface 12b, and on the first lateral surface 12c and the second lateral surface 12d, the thickness of the fired layer in the central portion in the length direction z of the first end surface base electrode layer 32a and the second end surface base electrode layer 32b located on the first main surface 12a and the second main surface 12b, and on the first lateral surface 12c and the second lateral surface 12d, is, for example, preferably between about 5 μm and about 20 μm inclusive.

In a case where the fired layer is provided as the first lateral surface base electrode layer 32c and the second lateral surface base electrode layer 32d, the thickness of the fired layer in the central portion in the lamination direction x of the first lateral surface base electrode layer 32c and the second lateral surface base electrode layer 32d located on the first lateral surface 12c and the second lateral surface 12d is, for example, preferably between about 20 μm and about 50 μm inclusive.

In a case where the fired layer is provided as the first lateral surface base electrode layer 32c and the second lateral surface base electrode layer 32d on the first main surface 12a and the second main surface 12b, the thickness of the fired layer in the central portion in the length direction z of the first lateral surface base electrode layer 32c and the second lateral surface base electrode layer 32d located on the first main surface 12a and the second main surface 12b is, for example, preferably between about 5 μm and about 20 μm inclusive.

Next, a case in which the base electrode layer 32 is made of an electrically conductive resin layer will be described. The electrically conductive resin layer may be provided on the fired layer to cover the fired layer, or may be directly provided on the multilayer body 12 without providing a fired layer. The electrically conductive resin layer may completely cover the fired layer, or may cover only a portion of the fired layer. Furthermore, the electrically conductive resin layer may include a plurality of layers.

The electrically conductive resin layer includes, for example, a thermosetting resin and a metal. The electrically conductive resin layer includes, for example, a thermosetting resin, thus having greater flexibility than a fired layer including a plating film or a fired electrically conductive paste. Therefore, even when physical impact or shock due to thermal cycling is applied to the multilayer ceramic capacitor 10, the electrically conductive resin layer can define and function as a buffer layer and prevent cracks in the multilayer ceramic capacitor 10.

It is possible to use, for example, Ag, Cu, Ni, Sn, Bi, or an alloy including any thereof for the metal included in the electrically conductive resin layer. Metal powder coated with Ag on the surface of the metal powder may also be used. When using Ag-coated metal powder, for example, Cu, Ni, Sn, Bi, or an alloy thereof is preferably used as the metal powder. The reason for using Ag electrically conductive metal powder for the electrically conductive metal is that Ag, with the lowest specific resistance among metals, is suitable as an electrode material, and being a noble metal, Ag resists oxidation and exhibits excellent weather resistance. The reason for using a metal coated with Ag is that the base metal can be inexpensive while maintaining the above-described characteristics of Ag.

The metal included in the electrically conductive resin layer mainly provides electrical conductivity of the electrically conductive resin layer. Specifically, an electrically conductive path is provided inside the electrically conductive resin layer through contact between the metal particles (electrically conductive fillers) included in the electrically conductive resin layer.

The metal included in the electrically conductive resin layer may be spherical, flaky, or the like, but a mixture of spherical and flaky metal powders is preferably used. The average particle size of the metal included in the electrically conductive resin layer is not particularly limited. The average particle size of the metal (electrically conductive filler) included in the electrically conductive resin layer may be, for example, between about 0.3 μm and about 10 μm inclusive.

The metal included in the electrically conductive resin layer is, for example, preferably included in an amount between about 35 vol % and about 75 vol % inclusive relative to the total volume of the conductive resin.

As the resin in the electrically conductive resin layer, it is possible to use various known thermosetting resins such as, for example, epoxy resin, phenol resin, urethane resin, silicone resin, or polyimide resin. Among them, epoxy resin is one of the preferable resins due to the excellent heat resistance, moisture resistance, and adhesion.

The resin included in the electrically conductive resin layer is, for example, preferably included in an amount of about 25 vol % or more and about 65 vol % or less relative to the total volume of the conductive resin.

The electrically conductive resin layer preferably includes a curing agent in addition to the thermosetting resin. As the curing agent, in the case where an epoxy resin is used as the base resin, it is possible to use various known compounds such as, for example, phenol-based, amine-based, acid anhydride-based, imidazole-based, active ester-based, or amide-imide-based compounds as curing agents for the epoxy resin.

In a case where an electrically conductive resin electrode layer is provided as the first end surface base electrode layer 32a and the second end surface base electrode layer 32b, the thickness of the electrically conductive resin electrode layer in the central portion in the lamination direction x of the first end surface base electrode layer 32a and the second end surface base electrode layer 32b located on the first end surface 12e and the second end surface 12f is, for example, preferably between about 20 μm and about 70 μm inclusive.

In a case where the electrically conductive resin electrode layer is provided as the first end surface base electrode layer 32a and the second end surface base electrode layer 32b on the first main surface 12a and the second main surface 12b, and on the first lateral surface 12c and the second lateral surface 12d, the thickness of the electrically conductive resin electrode layer in the central portion in the length direction z of the first end surface base electrode layer 32a and the second end surface base electrode layer 32b located on the first main surface 12a and the second main surface 12b, and on the first lateral surface 12c and the second lateral surface 12d, is, for example, preferably between about 5 μm and about 20 μm inclusive.

In a case where the electrically conductive resin electrode layer is provided as the first lateral surface base electrode layer 32c and the second lateral surface base electrode layer 32d, the thickness of the electrically conductive resin electrode layer in the central portion in the lamination direction x of the first lateral surface base electrode layer 32c and the second lateral surface base electrode layer 32d located on the first lateral surface 12c and the second lateral surface 12d is, for example, preferably between about 20 μm and about 70 μm inclusive.

In a case where the electrically conductive resin electrode layer is provided as the first lateral surface base electrode layer 32c and the second lateral surface base electrode layer 32d on the first main surface 12a and the second main surface 12b, the thickness of the electrically conductive resin electrode layer in the central portion in the length direction z of the first lateral surface base electrode layer 32c and the second lateral surface base electrode layer 32d located on the first main surface 12a and the second main surface 12b is, for example, preferably between about 5 μm and about 20 μm inclusive.

Only the electrically conductive resin electrode layer may be provided as the first end surface base electrode layer 32a and the second end surface base electrode layer 32b, and similarly, only the electrically conductive resin electrode layer may be provided as the first lateral surface base electrode layer 32c and the second lateral surface base electrode layer 32d.

### Plated Layers

The plated layers 34 include a first end surface plated layer 34a, a second end surface plated layer 34b, a first lateral surface plated layer 34c, and a second lateral surface plated layer 34d.

The first end surface plated layer 34a covers the first end surface base electrode layer 32a. The second end surface plated layer 34b covers the second end surface base electrode layer 32b. The first lateral surface plated layer 34c covers the first lateral surface base electrode layer 32c. The second lateral surface plated layer 34d covers the second lateral surface base electrode layer 32d.

The plated layer 34 includes, for example, at least one of Cu, Ni, Sn, Ag, Pd, Ag—Pd alloy, Au, or the like.

The plated layer 34 may include a plurality of layers. The plated layer 34 is, for example, preferably of a two-layer structure in which Ni plating and Sn plating are provided in this order. The Ni plated layer can prevent the base electrode layer 32 from being corroded by solder when the multilayer ceramic capacitor 10 is mounted. The Sn plated layer improves the solder wettability when mounting the multilayer ceramic capacitor 10, and enables easy mounting. When the plated layer 34 has a three-layer configuration, for example, the plated layer preferably includes Sn plating, Ni plating, and Sn plating in this order from the multilayer body 12 side.

The thickness of each layer of the plated layer 34 is, for example, preferably between about 1 μm and about 6 μm inclusive.

Any or all of the first end surface external electrode 30a, the second end surface external electrode 30b, the first lateral surface external electrode 30c, and the second lateral surface external electrode 30d may include a plated layer directly on the surface of the multilayer body 12. That is, the multilayer ceramic capacitor 10 may include a configuration including the plated layer directly electrically connected to the first internal electrode layer 16a and the second internal electrode layer 16b. In such a case, a catalyst may be applied to the surface of the multilayer body 12 as a pretreatment before forming the direct plated layer.

The first direct plated layer is provided on the first end surface 12e and is joined with the first internal electrode layer 16a. The second direct plated layer is provided on the second end surface 12f and is joined with the first internal electrode layer 16a. The third direct plated layer is provided on the first lateral surface 12c and is joined with the second internal electrode layer 16b. The fourth direct plated layer is provided on the second lateral surface 12d and is joined with the second internal electrode layer 16b.

Each of the direct plated layers preferably includes, for example, at least one of Cu, Ni, Sn, Pb, Au, Ag, Pd, Bi, or Zn, or an alloy including any of these metals.

For example, in a case where the first internal electrode layer 16a and the second internal electrode layer 16b include Ni, the direct plated layer preferably includes Cu that has good bondability with Ni.

In a case where the plated layer 34 is provided directly on the multilayer body 12, the thickness of each layer of the plated layer 34 is, for example, preferably between about 1 μm and about 15 μm inclusive.

In a case where the plated layer 34 is provided directly on the multilayer body 12, the plated layer 34 preferably does not include glass. The metal content per unit volume of the plated layer 34 is, for example, preferably about 99 vol % or more.

A case will now be described in which the base electrode layer 32 is a thin film layer, and the plated layer 34 is provided directly on the thin film layer.

The first thin film layer provided on the first main surface 12a is connected to the first direct plated layer that wraps around from the first end surface 12e. The second thin film layer provided on the first main surface 12a is connected to the second direct plated layer that wraps around from the second end surface 12f. The third thin film layer provided on the first main surface 12a is connected to the third direct plated layer that wraps around from the first lateral surface 12c. The fourth thin film layer provided on the first main surface 12a is connected to the fourth direct plated layer that wraps around from the second lateral surface 12d.

Similarly, the first thin film layer provided on the second main surface 12b is connected to the first direct plated layer that wraps around from the first end surface 12e. The second thin film layer provided on the second main surface 12b is connected to the second direct plated layer that wraps around from the second end surface 12f. The third thin film layer provided on the second main surface 12b is connected to the third direct plated layer that wraps around from the first lateral surface 12c. The fourth thin film layer provided on the second main surface 12b is connected to the fourth direct plated layer that wraps around from the second lateral surface 12d.

The dimension of the multilayer ceramic capacitor 10 including the multilayer body 12 and the external electrodes 30 in the length direction z is referred to as L dimension. The L dimension is, for example, preferably between about 1.0 mm and about 3.2 mm inclusive. The dimension of the multilayer ceramic capacitor 10 including the multilayer body 12 and the external electrodes 30 in the lamination direction x is referred to as T dimension. The T dimension is, for example, preferably between about 0.3 mm and about 2.5 mm inclusive. The dimension of the multilayer ceramic capacitor 10 including the multilayer body 12 and the external electrodes 30 in the width direction y is referred to as W dimension. The W dimension is, for example, preferably between about 0.5 mm and about 2.5 mm inclusive.

### (b) Conductor Portion

Next, the conductor portion 40 will be described. The conductor portion 40 is electrically connected to the first end surface external electrode 30a and the second end surface external electrode 30b of the multilayer ceramic capacitor 10 via an electrically conductive adhesive 42.

The conductor portion 40 is configured, for example, as an interposer board.

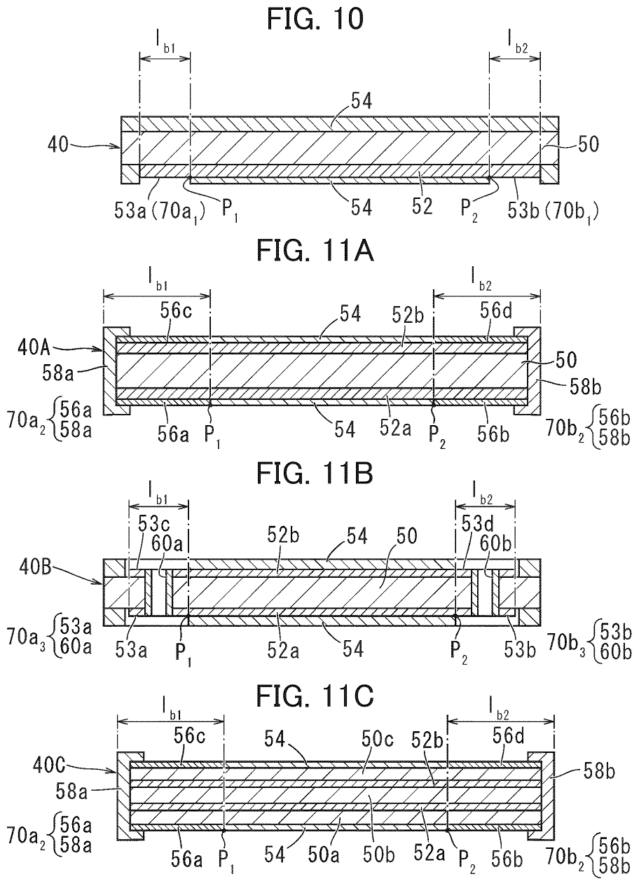

FIG. 10 is a cross-sectional view showing an example of the conductor portion 40. The conductor portion 40 is configured as a single-sided board. Specifically, the conductor portion 40 includes an insulating board 50, and an electrically conductive pattern 52 provided on one main surface of the insulating board 50. A protective layer 54 is provided on the surface of the electrically conductive pattern 52 so as to expose a portion of the electrically conductive pattern 52. The exposed portions of the electrically conductive pattern 52 include a pair of exposed electrode portions 53a and 53b. The protective layer 54 is provided over the entire or substantially the entire surface of the other main surface of the insulating board 50. The protective layer 54 may not necessarily be provided on the other main surface of the insulating board 50.

As shown in FIG. 2 or FIG. 10, the conductor portion 40 includes a first connection region 70al that is located on one of the surfaces of the conductor portion 40 opposed to each other in the lamination direction x, the surface being on the multilayer ceramic capacitor 10 side, the first connection region 70al being located on the first end surface 12e side. In the conductor portion 40, the first connection region 70al includes one of the exposed electrode portions 53a. The conductor portion 40 includes a second connection region 70b1 that is located on one of the surfaces of the conductor portion 40 opposed to each other in the lamination direction x, the surface being on the multilayer ceramic capacitor 10 side, the first connection region 70b1 being located on the second end surface 12f side. In the conductor portion 40, the second connection region 70b1 includes the other one of the exposed electrode portions 53b. The connection regions 70al and 70b1 are regions in the conductor portion 40 that are covered with the electrically conductive adhesive 42 such as solder, for example, when the conductor portion 40 is connected to the multilayer ceramic capacitor 10.

The dimension lb1 of the first connection region 70al in the length direction z may be shorter than the dimension la1 of the first end surface external electrode 30a in the length direction z. The dimension lb2 of the second connection region 70b1 in the length direction z may be shorter than the dimension la2 of the second end surface external electrode 30b in the length direction z.

As shown in FIG. 2, a tip P1 on the center side in the length direction z of the multilayer ceramic capacitor 10 of the first connection region 70al is located closer to the first end surface 12e side than a tip P3 on the center side in the length direction z of the first end surface external electrode 30a provided on the first main surface 12a. The first connection region 70al and the first end surface external electrode 30a are electrically connected by the electrically conductive adhesive 42.

As shown in FIG. 2, a tip P2 on the center side in the length direction z of the multilayer ceramic capacitor 10 of the second connection region 70b1 is located closer to the second end surface 12f side than a tip P4 on the center side in the length direction z of the second end surface external electrode 30b provided on the first main surface 12a. The second connection region 70b1 and the second end surface external electrode 30b are electrically connected by the electrically conductive adhesive 42.

The conductor portion 40 may have a rectangular or substantially rectangular shape, a disk shape, or any other shape without limitation. However, in a case where the conductor portion 40 is provided on the first main surface 12a or the second main surface 12b, increasing the thickness of the conductor portion 40 in the lamination direction x increases the dimension of the multilayer ceramic electronic component 100 in the lamination direction x. Therefore, when the conductor portion 40 is provided on the first main surface 12a or the second main surface 12b of the multilayer ceramic electronic component 100, the thickness of the conductor portion 40 is preferably reduced.

### (c) Modified Examples of the Conductor Portion

As described above, the conductor portion 40 is configured as a single-sided board such as an interposer board, for example, but may also be configured as a double-sided board or a multi-layered board. The following describes modified examples of the conductor portion 40.

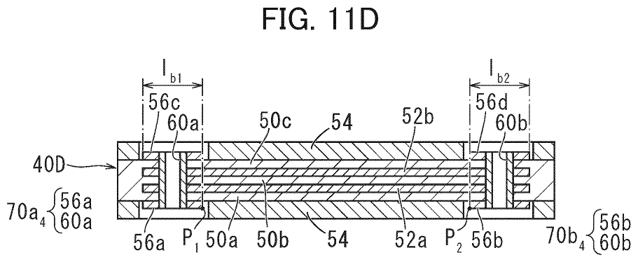

A first modified example of the conductor portion 40, referred to as conductor portion 40A, will be described. FIG. 11A is a cross-sectional view showing the first modified example of the conductor portion 40A. The conductor portion 40A is configured as a double-sided board. Specifically, the conductor portion 40A includes an insulating board 50, an electrically conductive pattern 52a provided on one main surface of the insulating board 50, and an electrically conductive pattern 52b provided on the other main surface of the insulating board 50. A land electrode portion 56a is provided on the surface of the electrically conductive pattern 52a on one end side of the insulating board 50, and a land electrode portion 56b is provided on the surface of the electrically conductive pattern 52a on the other end side of the insulating board 50. On one main surface of the insulating board 50, a protective layer 54 is provided on a portion of the electrically conductive pattern 52a where the land electrode portions 56a and 56b are not provided. A land electrode portion 56c is provided on the surface of the electrically conductive pattern 52b on one end side of the insulating board 50, and a land electrode portion 56d is provided on the surface of the electrically conductive pattern 52b on the other end side of the insulating board 50. On the other main surface of the insulating board 50, a protective layer 54 is provided on a portion of the electrically conductive pattern 52b where the land electrode portions 56c and 56d are not provided. An interlayer connection conductor (end-surface through-hole) 58a to electrically connect the land electrode portion 56a and the land electrode portion 56c is provided on one end side of the insulating board 50. An interlayer connection conductor (end-surface through-hole) 58b to electrically connect the land electrode portions 56b and the land electrode portion 56d is provided on the other end side of the insulating board 50.

The conductor portion 40A includes a first connection region 70a2 that is located on one of the surfaces of the conductor portion 40A opposed to each other in the lamination direction x, the surface being on the multilayer ceramic capacitor 10 side, the first connection region 70a2 being located on the first end surface 12e side. In the conductor portion 40A, the first connection region 70a2 includes the land electrode portion 56a and the interlayer connection conductor 58a. The conductor portion 40A includes a second connection region 70b2 that is located on one of the surfaces of the conductor portion 40A opposed to each other in the lamination direction x, the surface being on the multilayer ceramic capacitor 10 side, the first connection region 70b2 being located on the second end surface 12f side. In the conductor portion 40A, the second connection region 70b2 includes the land electrode portion 56b and the interlayer connection conductor 58b. The connection regions 70a2 and 70b2 are areas of the conductor portion 40A covered with an electrically conductive adhesive 42 such as solder, for example, when the conductor portion 40A is connected to the multilayer ceramic capacitor 10.

The dimension lb1 of the first connection region 70a2 in the length direction z may be shorter than the dimension la1 of the first end surface external electrode 30a in the length direction z. The dimension lb2 of the second connection region 70b2 in the length direction z may be shorter than the dimension la2 of the second end surface external electrode 30b in the length direction z.

The tip P1 on the center side in the length direction z of the multilayer ceramic capacitor 10 of the first connection region 70a2 is located closer to the first end surface 12e side than the tip P3 on the center side in the length direction z of the first end surface external electrode 30a provided on the first main surface 12a. The first connection region 70a2 and the first end surface external electrode 30a are electrically connected by the electrically conductive adhesive 42.

The tip P2 on the center side in the length direction z of the multilayer ceramic capacitor 10 of the second connection region 70b2 is located closer to the second end surface 12f side than the tip P4 on the center side in the length direction z of the second end surface external electrode 30b provided on the first main surface 12a. The second connection region 70b2 and the second end surface external electrode 30b are electrically connected by the electrically conductive adhesive 42.

Next, a second modified example of the conductor portion 40, referred to as a conductor portion 40B, will be described. FIG. 11B is a cross-sectional view showing the second modified example of the conductor portion. The conductor portion 40B is configured as a double-sided board. Specifically, the conductor portion 40B includes an insulating board 50, an electrically conductive pattern 52a provided on one main surface of the insulating board 50, and an electrically conductive pattern 52b provided on the other main surface of the insulating board 50. A protective layer 54 is provided on the surface of the electrically conductive pattern 52a so as to expose a portion of the electrically conductive pattern 52a. The exposed portions of the electrically conductive pattern 52a include a pair of exposed electrode portions 53a and 53b. A protective layer 54 is provided on the surface of the electrically conductive pattern 52b so as to expose a portion of the electrically conductive pattern 52b. The exposed portions of the electrically conductive pattern 52b include a pair of exposed electrode portions 53c and 53d. In order to electrically connect the exposed electrode portion 53a and the exposed electrode portion 53c, an interlayer connection conductor (through-hole) 60a is provided so as to penetrate the insulating board 50 from one main surface to the other. In order to electrically connect the exposed electrode portion 53b and the exposed electrode portion 53d, an interlayer connection conductor (through-hole) 60b is provided so as to penetrate the insulating board 50 from one main surface to the other.

The conductor portion 40B includes a first connection region 70a3 that is located on one of the surfaces of the conductor portion 40B opposed to each other in the lamination direction x, the surface being on the multilayer ceramic capacitor 10 side, the first connection region 70a3 being located on the first end surface 12e side. In the conductor portion 40B, the first connection region 70a3 includes the one exposed electrode portion 53a and the interlayer connection conductor 60a. The conductor portion 40B includes a second connection region 70b3 that is located on one of the surfaces of the conductor portion 40B opposed to each other in the lamination direction x, the surface being on the multilayer ceramic capacitor 10 side, the second connection region 70b3 being located on the second end surface 12f side. In the conductor portion 40B, the second connection region 70b3 includes the other exposed electrode portion 53b and the interlayer connection conductor 60b. The connection regions 70a3 and 70b3 are areas of the conductor portion 40B, the areas being covered with an electrically conductive adhesive 42 such as solder, for example, when the conductor portion 40B is connected to the multilayer ceramic capacitor 10.

The dimension lb1 of the first connection region 70a3 in the length direction z may be shorter than the dimension la1 of the first end surface external electrode 30a in the length direction z. The dimension lb2 of the second connection region 70b3 in the length direction z may be shorter than the dimension la2 of the second end surface external electrode 30b in the length direction z.

The tip P1 on the center side in the length direction z of the multilayer ceramic capacitor 10 of the first connection region 70a3 is located closer to the first end surface 12e side than the tip P3 on the center side in the length direction z of the first end surface external electrode 30a provided on the first main surface 12a. The first connection region 70a3 and the first end surface external electrode 30a are electrically connected by the electrically conductive adhesive 42.

The tip P2 on the center side in the length direction z of the multilayer ceramic capacitor 10 of the second connection region 70b3 is located closer to the second end surface 12f side than a tip P4 on the center side in the length direction z of the second end surface external electrode 30b provided on the first main surface 12a. The second connection region 70b3 and the second end surface external electrode 30b are electrically connected by the electrically conductive adhesive 42.

Next, a third modified example of the conductor portion 40, referred to as a conductor portion 40C, will be described. FIG. 11C is a cross-sectional view showing the third modified example of the conductor portion. The conductor portion 40C is configured as a multi-layered board. Specifically, the conductor portion 40C includes a plurality of insulating boards 50a to 50c, and electrically conductive patterns 52a and 52b alternately arranged via the insulating boards 50a to 50c. The electrically conductive patterns 52a and 52b are provided so as to be exposed from both end surfaces of the insulating boards 50a to 50c. A land electrode portion 56a is provided on a surface at one end side of the insulating board 50a, which is located on one main surface side of the conductor portion 40C. A land electrode portion 56b is provided on a surface at the other end side of the insulating board 50c, which is located on the opposite main surface side of the conductor portion 40C. A protective layer 54 is provided on a portion of the surface of the insulating board 50a where the land electrode portions 56a and 56b are not provided. A land electrode portion 56c is provided on a surface at one end side of the insulating board 50c, which is located on the other main surface side of the conductor portion 40C. A land electrode portion 56d is provided on a surface at the other end side of the insulating board 50c, which is located on the other main surface side of the conductor portion 40C. A protective layer 54 is provided on a portion of the surface of the insulating board 50c where the land electrode portions 56c and 56d are not provided. An interlayer connection conductor (end-surface through-hole) 58a to electrically connect the land electrode portion 56a and the land electrode portion 56c is provided on one end side of the insulating boards 50a to 50c. In this case, the interlayer connection conductor 58a is electrically connected to both of the electrically conductive patterns 52a and 52b. An interlayer connection conductor (end-surface through-hole) 58b to electrically connect the land electrode portion 56b and the land electrode portion 56d is provided on the other end side of the insulating boards 50a to 50c. In this case, the interlayer connection conductor 58b is electrically connected to both the electrically conductive patterns 52a and 52b.

The conductor portion 40C includes a first connection region 70a2 that is located on one of the surfaces of the conductor portion 40C opposed to each other in the lamination direction x, the surface being on the multilayer ceramic capacitor 10 side, the first connection region 70a2 being located on the first end surface 12e side. In the conductor portion 40C, the first connection region 70a2 includes the land electrode portion 56a and the interlayer connection conductor 58a. The conductor portion 40C includes a second connection region 70b2 that is located on one of the surfaces of the conductor portion 40C opposed to each other in the lamination direction x, the surface being on the multilayer ceramic capacitor 10 side, the second connection region 70b2 being located on the second end surface 12f side. In the conductor portion 40C, the second connection region 70b2 includes the land electrode portion 56b and the interlayer connection conductor 58b. The connection regions 70a2 and 70b2 are the regions of the conductor portion 40C, the areas being covered with the electrically conductive adhesive 42 such as solder, for example, when the conductor portion 40C is connected to the multilayer ceramic capacitor 10.

The dimension lb1 of the first connection region 70a2 in the length direction z may be shorter than the dimension la1 of the first end surface external electrode 30a in the length direction z. The dimension lb2 of the second connection region 70b2 in the length direction z may be shorter than the dimension la2 of the second end surface external electrode 30b in the length direction z.

The tip P1 on the center side in the length direction z of the multilayer ceramic capacitor 10 of the first connection region 70a2 is located closer to the first end surface 12e side than the tip P3 on the center side in the length direction z of the first end surface external electrode 30a provided on the first main surface 12a. The first connection region 70a2 and the first end surface external electrode 30a are electrically connected by the electrically conductive adhesive 42.

The tip P2 on the center side in the length direction z of the multilayer ceramic capacitor 10 of the second connection region 70b2 is located closer to the second end surface 12f side than the tip P4 on the center side in the length direction z of the second end surface external electrode 30b provided on the first main surface 12a. The second connection region 70b2 and the second end surface external electrode 30b are electrically connected by the electrically conductive adhesive 42.

Next, a fourth modified example of the conductor portion 40, referred to as a conductor portion 40D, will be described. FIG. 11D is a cross-sectional view showing the fourth modified example of the conductor portion. The conductor portion 40D is configured as a multi-layered board. Specifically, the conductor portion 40D includes a plurality of insulating boards 50a to 50c, and electrically conductive patterns 52a and 52b alternately arranged via the insulating boards 50a to 50c. A protective layer 54 is provided on the surface of the insulating board 50a located on one main surface side of the conductor portion 40C so as to expose a portion of the insulating board 50a. A pair of land electrode portions 56a and 56b are provided on the exposed portions of the insulating board 50a. A protective layer 54 is provided on the surface of the insulating board 50c located on the other main surface side of the conductor portion 40C so as to expose a portion of the insulating board 50c. A pair of land electrode portions 56c and 56d are provided on the exposed portions of the insulating board 50c. In order to electrically connect the land electrode portion 56a and the land electrode portion 56c, an interlayer connection conductor (through-hole) 60a is provided to penetrate from the surface of the insulating board 50a to the surface of the insulating board 50c. In this case, the interlayer connection conductor 60a is electrically connected to both of the electrically conductive patterns 52a and 52b. In order to electrically connect the land electrode portion 56b and the land electrode portion 56d, an interlayer connection conductor (through-hole) is provided to penetrate from the surface of the insulating board 50a to the surface of the insulating board 50c. In this case, the interlayer connection conductor 60b is electrically connected to both of the electrically conductive patterns 52a and 52b.

The conductor portion 40D includes a first connection region 70a2 that is located on one of the surfaces of the conductor portion 40D opposed to each other in the lamination direction x, the surface being on the multilayer ceramic capacitor 10 side, the first connection region 70a4 being located on the first end surface 12e side. In the conductor portion 40D, the first connection region 70a4 includes the land electrode portion 56a and the interlayer connection conductor 60a. The conductor portion 40D includes a second connection region 70b4 that is located on one of the surfaces of the conductor portion 40D opposed to each other in the lamination direction x, the surface being on the multilayer ceramic capacitor 10 side, the second connection region 70b4 being located on the second end surface 12f side. In the conductor portion 40D, the second connection region 70b4 includes the land electrode portion 56b and the interlayer connection conductor 60b. The connection regions 70a4 and 70b4 are areas in the conductor portion 40D, the areas being covered with an electrically conductive adhesive 42 such as solder, for example, when the conductor portion 40D is connected to the multilayer ceramic capacitor 10.

The dimension lb1 of the first connection region 70a4 in the length direction z may be shorter than the dimension la1 of the first end surface external electrode 30a in the length direction z. The dimension lb2 of the second connection region 70b4 in the length direction z may be shorter than the dimension la2 of the second end surface external electrode 30b in the length direction z.

The tip P1 on the center side in the length direction z of the multilayer ceramic capacitor 10 of the first connection region 70a4 is located closer to the first end surface 12e side than the tip P3 on the center side in the length direction z of the first end surface external electrode 30a provided on the first main surface 12a. The first connection region 70a4 and the first end surface external electrode 30a are electrically connected by the electrically conductive adhesive 42.

The tip P2 on the center side in the length direction z of the multilayer ceramic capacitor 10 of the second connection region 70b4 is located closer to the second end surface 12f side than a tip P4 on the center side in the length direction z of the second end surface external electrode 30b provided on the first main surface 12a. The second connection region 70b4 and the second end surface external electrode 30b are electrically connected by the electrically conductive adhesive 42.

The insulating boards 50, 50a to 50c may include, for example, a base material impregnated with epoxy resin or polyimide resin, in which glass cloth (cloth) and glass nonwoven fabric are mixed, or may be made of a ceramic board manufactured by firing a sheet obtained by mixing ceramics and glass. The insulating boards 50, 50a to 50c may be configured as a single-layer board or as a multilayer laminated board. The thickness of the insulating boards 50, 50a to 50c is not particularly limited but is, for example, preferably between about 200 μm and about 800 μm inclusive.

The material of the electrically conductive patterns 52, 52a, and 52b is not particularly limited and may include, for example, metals such as Cu, Au, Pd, or Pt. The thickness of the electrically conductive patterns 52, 52a, and 52b, i.e., the dimension in the lamination direction x, is not particularly limited but is, for example, preferably between about 20 μm and about 200 μm inclusive.

The protective layer 54 may be, for example, an etching resist or a solder resist. The material of the protective layer 54 is not particularly limited.

The electrically conductive adhesive 42 for the conductor portion 40 may be, for example, a high-heat-resistant epoxy adhesive or solder.

As described above, the electrically conductive adhesive 42 electrically connects the first end surface external electrode 30a and the second end surface external electrode 30b of the multilayer ceramic capacitor 10. In other words, the conductor portion 40 is electrically connected to the first end surface external electrode 30a and the second end surface external electrode 30b of the multilayer ceramic capacitor 10 via the electrically conductive adhesive 42. By arranging the conductor portion 40 so as to electrically connect the first end surface external electrode 30a and the second end surface external electrode 30b of the multilayer ceramic capacitor 10, the direct current flows through the conductor portion 40, the current flowing through the multilayer ceramic capacitor 10 is reduced, and the temperature rise can be reduced or prevented.

The DC resistance RdcA of the conductor portion 40 is smaller than the DC resistance RdcB of the multilayer ceramic capacitor 10. That is, RdcA<RdcB.

Since the DC resistance RdcA of the conductor portion 40 is smaller than the DC resistance RdcB of the multilayer ceramic capacitor 10, the direct current flows through the conductor portion 40 more preferentially, the current flowing through the multilayer ceramic capacitor 10 is reduced, and the temperature rise can be reduced or prevented.

On the other hand, when the DC resistance RdcA of the conductor portion 40 becomes greater than the DC resistance RdcB of the multilayer ceramic capacitor 10, the current will flow through the multilayer ceramic capacitor 10 rather than the conductor portion 40, making it difficult to achieve the advantageous effect of large-current capability.

The conductor portion 40 is not electrically connected to the first lateral surface external electrode 30c and the second lateral surface external electrode 30d. By arranging the conductor portion 40 to be electrically connected only to the first end surface external electrode 30a and the second end surface external electrode 30b of the multilayer ceramic capacitor 10, the direct current flows through the conductor portion 40, the current flowing through the multilayer ceramic capacitor 10 is reduced, and the temperature rise can be reduced or prevented.

The DC resistance values of the conductor portion 40 and the multilayer ceramic capacitor 10 are measured after removing the electrically conductive adhesive 42 that bonds each component and disconnecting each component, and the respective DC resistance values are compared. The DC resistance values of the conductor portion 40 and the multilayer ceramic capacitor 10 are measured using a four-terminal method by applying about 100 mA, in accordance with JIS C 2139.

According to the multilayer ceramic electronic component 100 shown in FIG. 1, the DC resistance RdcA of the conductor portion 40 connected to the multilayer ceramic capacitor 10 is smaller than the DC resistance RdcB of the multilayer ceramic capacitor 10. With such a configuration, it is possible to allow the direct current to flow through the conductor portion, and the alternating current can be diverted to the multilayer ceramic capacitor 10. More specifically, since direct current tends to flow toward the path with lower DC resistance, the direct current preferentially flows through the conductor portion with lower DC resistance than the multilayer ceramic capacitor 10. On the other hand, since alternating current tends to flow toward the path with lower impedance, the alternating current preferentially flows through the multilayer ceramic capacitor 10 with lower impedance. With such a configuration, it is possible to reduce or prevent both an increase in the capacitance of the multilayer ceramic capacitor 10 and an increase in the DC resistance. Furthermore, it is possible to support the large-current capability simply by attaching the conductor portion 40 to an existing multilayer ceramic capacitor 10, without newly designing an internal configuration uniquely for each capacitance of the multilayer ceramic capacitor 10. With such a configuration, the scalability of the product lineup is also improved.

According to the multilayer ceramic electronic component 100 shown in FIG. 1, the tip P1 on the center side in the length direction z of the first connection region 70al is located closer to the first end surface 12e side than a tip P3 on the center side in the length direction z of the first end surface external electrode 30a provided on the first main surface 12a. Similarly, the tip P2 on the center side in the length direction z of the second connection region 70b1 is located closer to the second end surface 12f side than the tip P4 on the center side in the length direction z of the second end surface external electrode 30b provided on the first main surface 12a. Therefore, when reflowing the electrically conductive adhesive 42 such as solder, for example, used to connect the conductor portion 40 and the multilayer ceramic capacitor 10, stress generated at the tips P3 and P4 on the central side in the length direction z of the multilayer body 12 of the end surface external electrodes 30a and 30b provided on the first main surface 12a of the multilayer ceramic capacitor 10 is reduced, thus reducing the occurrence of cracks during reflow.

### 2. MOUNTING STRUCTURE OF MULTILAYER CERAMIC ELECTRONIC COMPONENT

Next, an example of a mounting configuration 500 of the multilayer ceramic electronic component 100 according to the present example embodiment will be described.

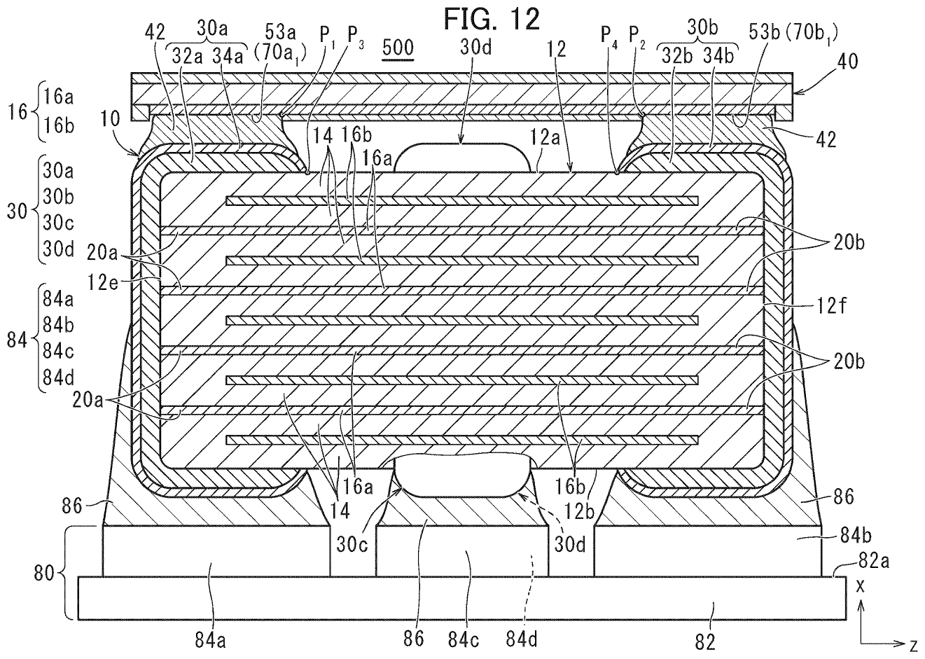

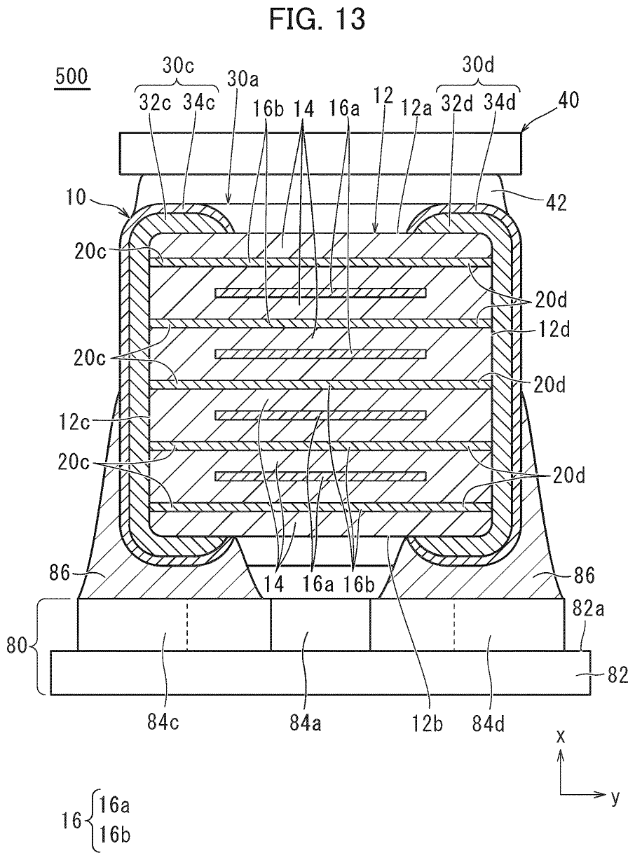

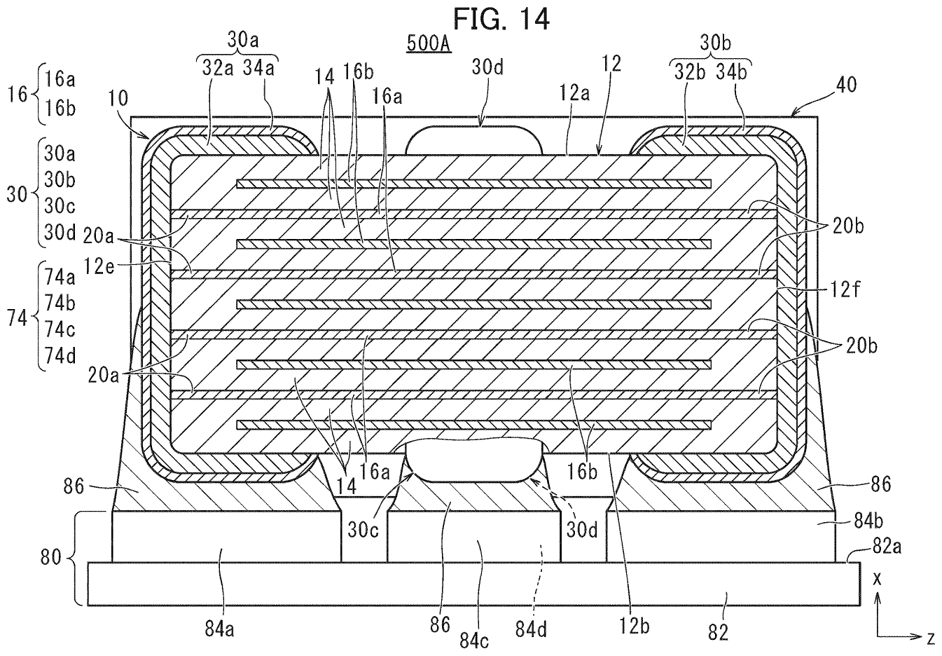

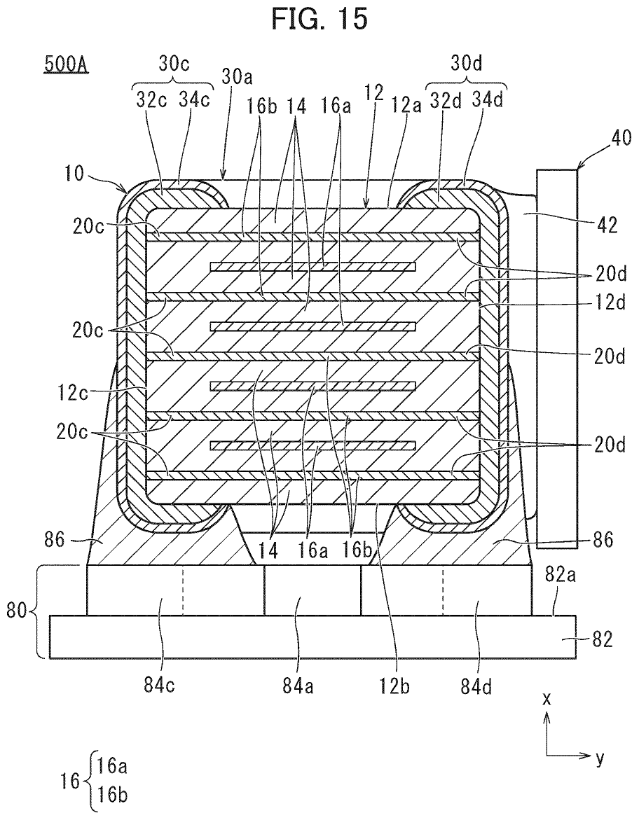

FIG. 12 is a cross-sectional view in the lamination direction, showing an example of a mounting configuration of a multilayer ceramic electronic component according to an example embodiment. FIG. 13 is a cross-sectional view in the width direction, showing the example of the mounting configuration of the multilayer ceramic electronic component according to the present example embodiment. FIG. 14 is a cross-sectional view in the lamination direction, showing another example of a mounting configuration of a multilayer ceramic electronic component according to an example embodiment. FIG. 15 is a cross-sectional view in the width direction, showing another example of a mounting configuration of a multilayer ceramic electronic component according to an example embodiment.

As shown in FIGS. 12 and 13, the mounting configuration 500 of the multilayer ceramic electronic component according to the present example embodiment includes the multilayer ceramic electronic component 100 according to the present example embodiment and a mounting board 80. The mounting board 80 includes a core material 82 of the board and connection conductors (conductor lands) 84.

The core material 82 of the board may include, for example, a board made of a base material obtained by impregnating a mixture of glass cloth (cloth) and glass nonwoven fabric with epoxy resin or polyimide resin, or a ceramic board manufactured by firing a sheet obtained by mixing ceramics and glass. The core material 82 of the board may be configured as a single-layer board or a multilayer laminated board. The thickness of the core material 82 of the board is not particularly limited but is, for example, preferably between about 200 μm and about 800 μm inclusive.

One main surface of the core material 82 of the board defines and functions as the board-side mounting surface 82a, on which the conductor lands 84 are provided and which defines and functions as the mounting surface for the multilayer ceramic electronic component 100.

The conductor lands 84 include a first conductor land 84a, a second conductor land 84b, a third conductor land 84c, and a fourth conductor land 84d.

The first conductor land 84a is a portion that is electrically connected and mechanically joined to the first end surface external electrode 30a of the multilayer ceramic capacitor 10 via a bonding material 86. The second conductor land 84b is a portion that is electrically connected and mechanically joined to the second end surface external electrode 30b of the multilayer ceramic capacitor 10 via the bonding material 86. The third conductor land 84c is a portion that is electrically connected and mechanically joined to the first lateral surface external electrode 30c of the multilayer ceramic capacitor 10 via the bonding material 86. The fourth conductor land 84d is a portion that is electrically connected and mechanically joined to the second lateral surface external electrode 30d of the multilayer ceramic capacitor 10 via the bonding material 86.

The conductor lands 84 may be provided on the main surface of the core material 82 of the board opposite to the board-side mounting surface 82a.

The material of the conductor lands 84 is not particularly limited and may include, for example, metals such as Cu, Au, Pd, or Pt. The thickness of the conductor lands 84, that is, the dimension in the lamination direction x, is not particularly limited, but is, for example, preferably between about 20 μm and about 200 μm inclusive. The bonding material 86 may be, for example, a high-heat-resistant epoxy adhesive or solder.

In the above description, the mounting board 80 corresponds to the mounting board. The core material 82 of the board corresponds to the core material of the board. The board-side mounting surface 82a corresponds to the mounting surface. The plurality of conductor lands 84 corresponds to the plurality of connection conductors. However, the connection conductor of the present invention is not limited by other applications, functions, shapes, names, or the like, as long as the connection conductor can be provided between the multilayer ceramic capacitor 10 and the mounting board 80 and can electrically connect the two, including lands.

In the mounting configuration 500 of the multilayer ceramic electronic component shown in FIGS. 12 and 13, the multilayer ceramic electronic component 100 is preferably mounted such that the conductor portion 40 of the multilayer ceramic electronic component 100 is provided in a direction opposite to the mounting board 80. In other words, the conductor portion 40 of the multilayer ceramic electronic component 100 is preferably provided on the first main surface side (non-mounting surface side) of the multilayer ceramic capacitor 10, and the multilayer ceramic capacitor 10 of the multilayer ceramic electronic component 100 is preferably mounted on the side of the mounting board 80. By mounting in this manner, the distance between the multilayer ceramic capacitor 10 and the mounting board 80 can be prevented from increasing, and the advantageous effect of low ESL can be more easily achieved. It is possible to perform mounting without affecting the mounting of the multilayer ceramic electronic component 100 to the mounting board.

As shown in FIGS. 14 and 15, in the mounting configuration 500A of the multilayer ceramic electronic component, the conductor portion 40 of the multilayer ceramic electronic component 100 may be provided on a surface orthogonal or substantially orthogonal to the mounting board 80. In other words, with respect to the multilayer ceramic electronic component 100, the conductor portion 40 may be provided on the first lateral surface 12c or the second lateral surface 12d of the multilayer ceramic capacitor 10. By mounting in this manner, the mounting configuration 500A of the multilayer ceramic electronic component can achieve the same or substantially the same advantageous effects as the mounting configuration 500 of the multilayer ceramic electronic component, and furthermore, the following advantageous effect can be achieved. That is, the length of the conductor portion 40 of the multilayer ceramic electronic component 100 can be determined in accordance with the T dimension, which is the length in the lamination direction x of the multilayer ceramic capacitor 10, thus enabling a low-profile design.

### 3. METHOD OF MANUFACTURING MULTILAYER CERAMIC ELECTRONIC COMPONENT

Hereinafter, an example of a method of manufacturing the multilayer ceramic capacitor 10 of the multilayer ceramic electronic component 100 according to an example embodiment of the present invention will be described.

### (a) Method of Manufacturing Multilayer Ceramic Capacitor

First, dielectric sheets for dielectric layers and electrically conductive paste for internal electrode layers are prepared. The dielectric sheet and the electrically conductive paste for internal electrode layers include a binder and a solvent. It is possible to use known binders and solvents.

Next, the electrically conductive paste for internal electrode layers is printed in a predetermined pattern on the dielectric sheet by, for example, screen printing or gravure printing. With such a configuration, dielectric sheets including patterns of the first internal electrode layers 16a and the second internal electrode layers 16b are prepared. More specifically, for example, separate screen masks for printing the first internal electrode layer 16a and for printing the second internal electrode layer 16b are prepared, and each of the internal electrode layers 16 of the present example embodiment can be printed using a printing machine capable of separately printing the two types of screen masks. Here, in order to obtain a desired configuration, a sheet on which the first internal electrode layer 16a is printed and a sheet on which the second internal electrode layer 16b is printed are laminated to form the portion that becomes the inner layer portion 15a. In the present example embodiment, the internal electrode layers 16 are printed by screen printing, for example.

Next, by laminating a predetermined number of dielectric sheets on which no pattern of internal electrode layers is printed, a portion that becomes the first outer layer portion 15b1 on the first main surface 12a side is formed. Thereafter, the portion that becomes the inner layer portion 15a prepared above is laminated, and then, by laminating a predetermined number of dielectric sheets on which no pattern of internal electrode layers is printed on top of the inner layer portion 15a, a portion that becomes the second outer layer portion 15b2 on the second main surface 12b side is formed. With such a configuration, a multilayer sheet is produced.

Next, the multilayer sheet is pressed in the lamination direction by, for example, a hydrostatic press, thus forming a multilayer block.

Subsequently, the multilayer block is cut to a predetermined size to obtain a multilayer chip. In this case, the corner portions and the ridge portions of the multilayer chip may be rounded by, for example, barrel polishing.

Next, the multilayer chip is fired to form the multilayer body 12. The firing temperature depends on the materials of the dielectric layer 14 and the internal electrode layer 16, and is, for example, preferably between about 900° C. and about 1400° C. inclusive.

The first lateral surface base electrode layer 32c of the first lateral surface external electrode 30c and the second lateral surface base electrode layer 32d of the second lateral surface external electrode 30d are formed on the first lateral surface 12c and on the second lateral surface 12d of the multilayer body 12, respectively, obtained by firing.

When the base electrode layers 32 are formed as fired layers, an electrically conductive paste including glass components and metal components is applied, and then a firing process is performed to form the base electrode layers 32. The firing temperature in this case is, for example, preferably between about 700° C. and about 900° C. inclusive. In the present example embodiment, the base electrode layers 32 are formed as fired layers.

Here, it is possible to use various methods to form the fired layers as the first lateral surface base electrode layer 32c and the second lateral surface base electrode layer 32d. For example, it is possible to form the first lateral surface base electrode layer 32c and the second lateral surface base electrode layer 32d by using a method in which an electrically conductive paste is extruded through a slit and applied. In this method, by increasing the extrusion amount of the electrically conductive paste, it is possible to form the first lateral surface base electrode layer 32c and the second lateral surface base electrode layer 32d not only on the first lateral surface 12c and the second lateral surface 12d, but also on a portion of the first main surface 12a and a portion of the second main surface 12b.

The roller transfer method may also be used for formation. In the case of the roller transfer method, the first lateral surface base electrode layer 32c and the second lateral surface base electrode layer 32d can also be formed on a portion of the first main surface 12a and a portion of the second main surface 12b, in addition to the first lateral surface 12c and the second lateral surface 12d, by increasing the pressing pressure during roller transfer.

Next, a first end surface base electrode layer 32a of the first end surface external electrode 30a and a second end surface base electrode layer 32b of the second end surface external electrode 30b are formed on the first end surface 12e and the second end surface 12f of the fired multilayer body 12 obtained by firing. Similar to the first lateral surface base electrode layer 32c and the second lateral surface base electrode layer 32d, in the case where the first end surface base electrode layer 32a and the second end surface base electrode layer 32b are formed as fired layers, an electrically conductive paste including a glass component and a metal component is applied, followed by a firing process to form the first end surface base electrode layer 32a and the second end surface base electrode layer 32b. The firing temperature in this case is, for example, preferably between about 700° C. and about 900° C. inclusive.

Regarding the firing process, the first end surface base electrode layer 32a of the first end surface external electrode 30a, the second end surface base electrode layer 32b of the second end surface external electrode 30b, the first lateral surface base electrode layer 32c of the first lateral surface external electrode 30c, and the second lateral surface base electrode layer 32d of the second lateral surface external electrode 30d may be fired simultaneously. Alternatively, the first lateral surface base electrode layer 32c of the first lateral surface external electrode 30c and the second lateral surface base electrode layer 32d of the second lateral surface external electrode 30d, which are on the lateral surface side, and the first end surface base electrode layer 32a of the first end surface external electrode 30a and the second end surface base electrode layer 32b of the second end surface external electrode 30b, which are on the end surface side, may each be fired separately.

In the case where the base electrode layer 32 is formed using an electrically conductive resin layer, it is possible to form the electrically conductive resin layer by the following method. The electrically conductive resin layer may be formed on the surface of the fired layer or may be directly formed on the multilayer body 12 without forming the fired layer.

As an example of a method of forming the electrically conductive resin layer, an electrically conductive resin paste including a thermosetting resin and metal components is applied onto the fired layer or the multilayer body 12, and then heat-treated at a temperature between, for example, about 250° C. and about 550° C. inclusive to thermally cure the resin and form the electrically conductive resin layer. The atmosphere during the heat treatment is, for example, preferably a nitrogen (N₂) atmosphere. In order to prevent resin scattering and to reduce or prevent oxidation of various metal components, the oxygen concentration is, for example, preferably about 100 ppm or less.

As an example of a method of applying the electrically conductive resin paste, it is possible to use methods similar to those used for forming the base electrode layer 32 as a fired layer, such as a method of extruding the electrically conductive resin paste from a slit for application or using a roller transfer method.

In the case where the base electrode layer 32 is formed as a thin film layer, for example, masking or the like is performed, and it is possible to form the base electrode layer 32 by a thin film forming method such as, for example, sputtering or vapor deposition in a desired area. The base electrode layer 32 formed as a thin film layer is a layer with a thickness of, for example, about 1 μm or less in which metal particles are deposited.

Finally, a plated layer 34 is formed. The plated layer 34 may be formed on the surface of the base electrode layer 32 or directly on the multilayer body 12. In the present example embodiment, the plated layer 34 is formed on the surface of the base electrode layer 32. More specifically, for example, a Ni plated layer and a Sn plated layer are formed on the base electrode layer 32. Either electrolytic plating or electroless plating may be used for the plating process. However, electroless plating requires pretreatment using a catalyst or the like in order to improve plating deposition rate, which is a disadvantage due to the complexity of the process. Therefore, electrolytic plating is generally preferable.

In this manner, it is possible to manufacture the multilayer ceramic capacitor 10 shown in FIG. 1.

### (b) Method of Manufacturing Conductor Portion

Next, an example of a method of manufacturing the conductor portion 40 of the multilayer ceramic electronic component 100 according to an example embodiment will be described.

It is possible to manufacture the conductor portion 40 by first producing an assembly of the conductor portion 40, and then singulating the conductor portion assembly.

The assembly of the conductor portion 40 is manufactured by a method that is the same as or similar to that used for general printed circuit boards.

The conductor portion 40, which is a single-sided board, is manufactured as follows. That is, first, a material in which, for example, a copper foil is provided on one main surface of an insulating base material is prepared, and this material is cut into predetermined dimensions. Next, an etching resist is printed on portions where the copper foil is to remain (e.g., electrically conductive patterns). Then, the copper foil portions not covered with the etching resist are removed by etching. Subsequently, the remaining etching resist is removed, thus forming the electrically conductive pattern. Next, in order to insulate between electrically conductive patterns and to prevent unnecessary solder attachment during soldering processes, a solder resist is printed and UV-cured to form a protective layer. Finally, surface treatment such as, for example, solder plating, electroless gold plating, or water-soluble flux treatment is performed on the exposed electrode portions, which are the areas where the electrically conductive pattern is exposed, for the purpose of improving solderability and preventing rust on the copper foil portions. Through the above process, an assembly of the conductor portion 40 as a single-sided board is manufactured.

The conductor portion 40B, which is an example of a double-sided board, is manufactured as follows, for example. That is, first, a material in which copper foils are provided on both main surfaces of an insulating board is prepared, and the material is cut into predetermined dimensions. Next, hole forming processes such as, for example, drilling of through-holes or via-holes are performed at predetermined positions of the cut material. Subsequently, in order to electrically connect the copper foil surfaces provided on both main surfaces of the insulating board, interlayer connection conductors (through-holes) are formed by through-hole plating. Next, dry films (etching resists) are laminated on both main surfaces of the insulating board. Then, exposure and development are performed to fire the dry film only on the inner layer pattern. Subsequently, unnecessary portions other than the electrically conductive pattern are removed to complete the resist for forming the electrically conductive pattern. Then, copper foils other than the electrically conductive patterns are removed by etching. Next, the remaining etching resist is peeled off, thus forming the electrically conductive pattern. After forming the electrically conductive pattern, in order to insulate between the electrically conductive patterns and to prevent solder from adhering to unnecessary portions in the soldering process, a protective layer is formed by forming a solder resist. Finally, surface treatments such as, for example, solder plating, electroless gold plating, or water-soluble flux processing are performed on the exposed portions of the electrically conductive patterns, for the purpose of improving solderability and preventing rust on the copper foil portions. In this manner, an assembly of the conductor portion 40B, which is an example of a double-sided board, is manufactured.

The conductor portion 40D, which is an example of a multi-layered board, is manufactured as follows, for example. That is, first, an inner layer board and outer layer boards including copper foils provided on the surfaces of insulating base materials are cut into predetermined dimensions. Next, dry films (etching resists) are laminated on both main surfaces of the cut materials. Then, exposure and development are performed to fire the dry film only on the inner layer pattern. Subsequently, unnecessary portions other than the electrically conductive patterns are removed to complete the resist for forming the electrically conductive patterns. Then, copper foils other than the electrically conductive patterns are removed by etching. Next, the remaining etching resist is peeled off, thus forming the electrically conductive patterns. Then, the inner layer board on which an electrically conductive pattern has been formed and the outer layer board are bonded together by pressing using a prepreg (insulating base material), thus manufacturing a multi-layered board. Subsequently, hole forming processes such as, for example, drilling of through-holes or via-holes are performed at predetermined positions of the manufactured multi-layered board. Then, in order to electrically connect the copper foil surfaces provided on both main surfaces of the multi-layered board, interlayer connection conductors (through-holes) are formed by through-hole plating. Next, dry films (etching resists) are laminated on both main surfaces of the multi-layered board. Then, exposure and development are performed to fire the dry film only on the outer layer pattern. Subsequently, unnecessary portions other than the electrically conductive patterns are removed to complete the resist for forming the electrically conductive patterns. Then, copper foils other than the electrically conductive patterns are removed by etching. Next, the remaining etching resist is peeled off, thus forming the electrically conductive patterns. After forming the electrically conductive patterns, in order to insulate between the electrically conductive patterns and to prevent solder from adhering to unnecessary portions in the soldering process, a protective layer is formed by forming a solder resist. Finally, surface treatments such as, for example, solder plating, electroless gold plating, or water-soluble flux processing are performed on the exposed portions of the electrically conductive patterns, for the purpose of improving solderability and preventing rust on the copper foil portions. In this manner, an assembly of the conductor portion 40D, which is an example of a multi-layered board, is manufactured.

### (c) Method of Manufacturing Multilayer Ceramic Electronic Component

Next, the assembly of the conductor portion 40 manufactured by the above method is singulated, and the multilayer ceramic capacitor 10 manufactured by the above example method is mounted. The same applies to the conductor portions 40A to 40D.

More specifically, a cutting support tape is attached to the assembly of the conductor portion 40. Next, the assembly of the conductor portion 40 is cut into predetermined sizes and singulated. Then, the singulated conductor portions 40 are transferred to a heat-resistant plate. During the transfer, a heat-resistant tape or adhesive may be provided on the heat-resistant plate. Subsequently, an electrically conductive adhesive 42 (solder) is printed onto the transferred singulated conductor portions 40, and the multilayer ceramic capacitor 10 is mounted using a mounter.

Here, when the multilayer ceramic capacitor 10 is mounted on the conductor portion 40 using a mounter, the tip P1 on the center side in the length direction z of the multilayer ceramic capacitor 10 of the first connection region 70al of the conductor portion 40 is located closer to the first end surface 12e side than the tip P3 on the center side in the length direction z of the first end surface external electrode 30a provided on the first main surface 12a. Similarly, the tip P2 on the center side in the length direction z of the multilayer ceramic capacitor 10 of the second connection region 70b1 of the conductor portion 40 is located closer to the second end surface 12f side than the tip P4 on the center side in the length direction z of the second end surface external electrode 30b provided on the first main surface 12a.

Next, soldering is performed in a reflow oven. Finally, the singulated conductor portions 40 are removed from the heat-resistant plate, and flux is washed off.

In this manner, the multilayer ceramic electronic component 100 shown in FIG. 1 is manufactured.

### 4. MODIFIED EXAMPLES OF MULTILAYER CERAMIC CAPACITOR ACCORDING TO EXAMPLE EMBODIMENTS

Hereinafter, modified examples (first to third modified examples) of a multilayer ceramic capacitor in a multilayer ceramic electronic component according to example embodiments of the present invention will be described. In each of these modified examples, the same reference numerals are assigned to components corresponding to those of the above-described example embodiments, and detailed descriptions thereof are omitted.

### (1) First Modified Example

A multilayer ceramic capacitor 10A according to the first modified example differs from the multilayer ceramic capacitor 10 of the present example embodiment only in the configuration of the multilayer body 12A of the multilayer ceramic capacitor 10A. Therefore, the same or corresponding components to those of the multilayer ceramic capacitor 10 are designated with the same reference numerals, and detailed description thereof is omitted.

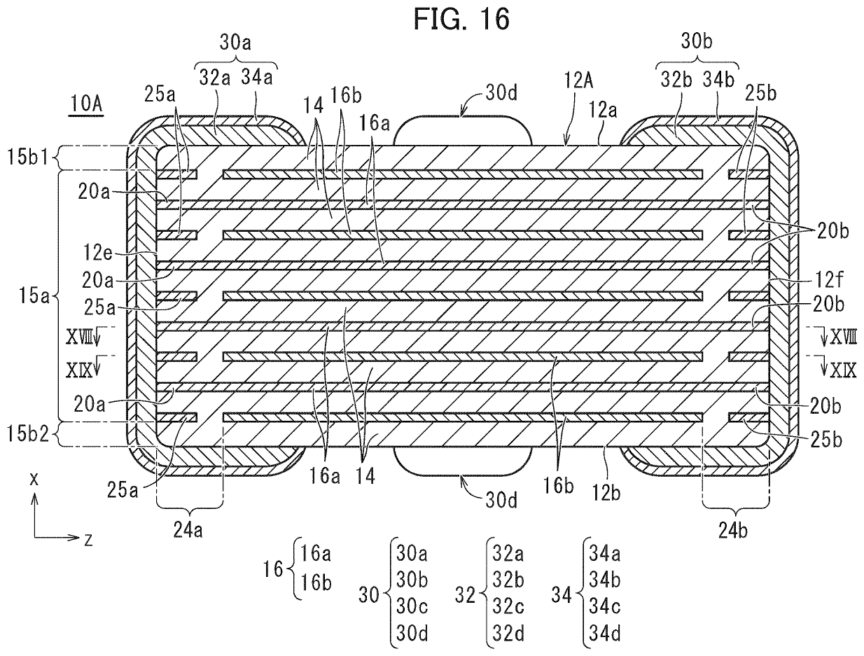

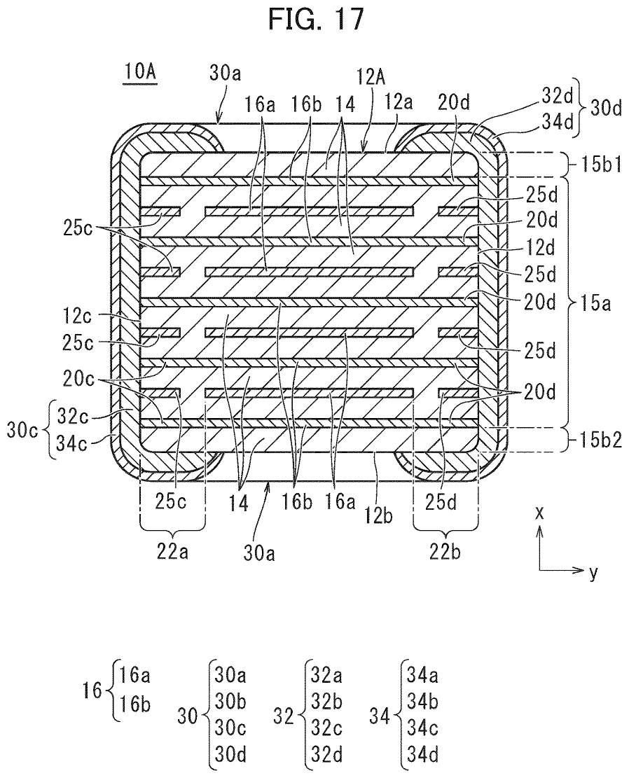

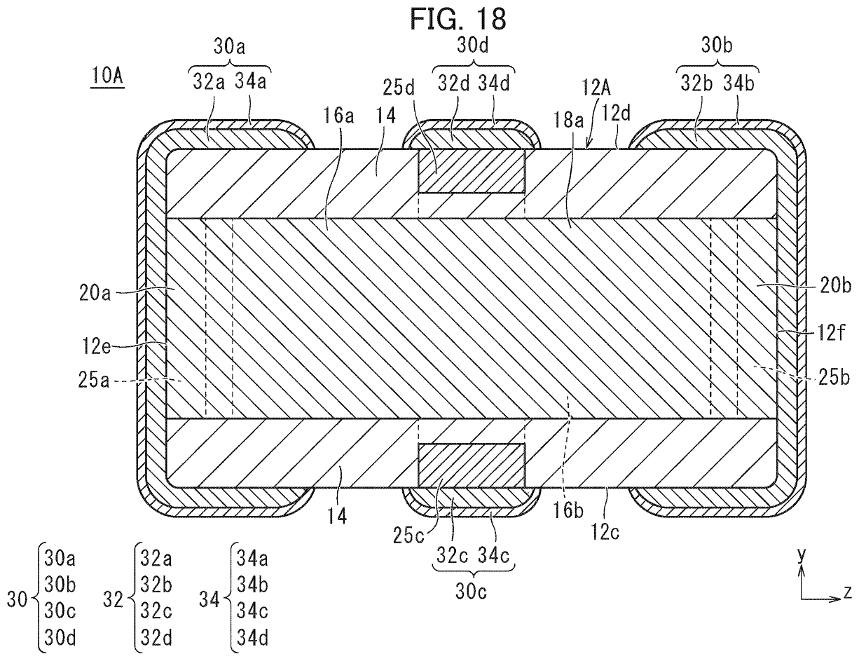

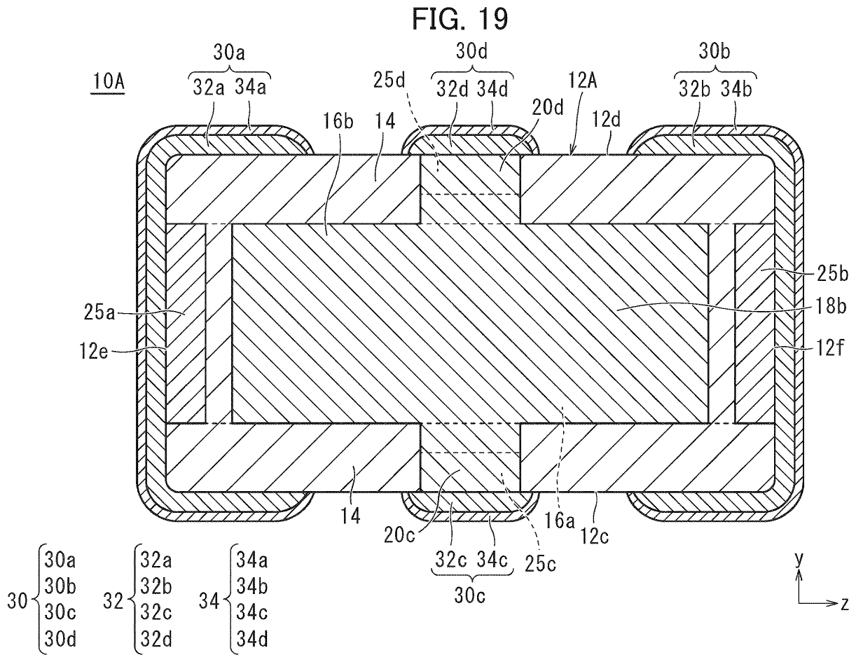

FIG. 16 is a cross-sectional view showing a first modified example of a multilayer ceramic capacitor according to an example embodiment of the present invention, and corresponds to the cross-sectional view of FIG. 6. FIG. 17 is a cross-sectional view showing a first modified example of the multilayer ceramic capacitor according to the present example embodiment of the present invention, and corresponds to the cross-sectional view of FIG. 7. FIG. 18 is a cross-sectional view taken along the line XVIII-XVIII in FIG. 16. FIG. 19 is a cross-sectional view taken along the line XIX-XIX in FIG. 16.

The multilayer ceramic capacitor 10A includes a multilayer body 12A and external electrodes 30.

The multilayer body 12A includes a plurality of dielectric layers 14 that are laminated. Further, the multilayer body 12A includes a first main surface 12a and a second main surface 12b on opposite sides in the lamination direction x, a first lateral surface 12c and a second lateral surface 12d on opposite sides in a width direction y orthogonal or substantially orthogonal to the lamination direction x, and a first end surface 12e and a second end surface 12f on opposite sides in a length direction z orthogonal or substantially orthogonal to both of the lamination direction x and the width direction y.

At the end portions (L-gaps) 24a and 24b of the multilayer body 12A, a first dummy electrode 25a is provided so as to be exposed at the first end surface 12e, and a second dummy electrode 25b is provided so as to be exposed at the second end surface 12f.

The first dummy electrode 25a and the second dummy electrode 25b are preferably provided on the same or substantially the same plane as the second internal electrode layer 16b and have the same or substantially the same thickness as the second internal electrode layer 16b.

By reducing the coverage of the first dummy electrode 25a and the second dummy electrode 25b, it is possible to shorten the current path.

The first dummy electrode 25a and the second dummy electrode 25b may also be provided in the first outer layer portion 15b1 and the second outer layer portion 15b2. In this case, the first dummy electrode 25a and the second dummy electrode 25b are preferably provided on portions corresponding to locations obtained by parallelly shifting the end portions (L-gaps) 24a and 24b of the multilayer body 12A in the lamination direction x. This arrangement facilitates the formation of the plated layer 34 in the case where the plated layer 34 is provided without the base electrode layer 32.

In the case where the first dummy electrode 25a and the second dummy electrode 25b are provided on the same or substantially the same plane as the second internal electrode layer 16b, it is possible to arrange the first dummy electrode 25a and the second dummy electrode 25b on the same or substantially the same plane as the second internal electrode layer 16b by printing the first dummy electrode 25a and the second dummy electrode 25b together with the second internal electrode layer 16b when printing the second internal electrode layer 16b.

A third dummy electrode 25c exposed on the first lateral surface 12c and a fourth dummy electrode 25d exposed on the second lateral surface 12d may be provided at the lateral portions (W-gaps) 22a and 22b of the multilayer body 12A.

The third dummy electrode 25c and the fourth dummy electrode 25d are preferably provided on the same or substantially the same plane as the first internal electrode layer 16a and have the same or substantially the same thickness as the first internal electrode layer 16a.

By reducing the coverage of the third dummy electrode 25c and the fourth dummy electrode 25d, it is possible to shorten the current path.

The third dummy electrode 25c and the fourth dummy electrode 25d may also be provided in the first outer layer portion 15b1 and the second outer layer portion 15b2. In this case, the third dummy electrode 25c and the fourth dummy electrode 25d are preferably provided on portions corresponding to locations obtained by parallelly shifting the lateral portions (W-gaps) 22a and 22b of the multilayer body 12A in the lamination direction x. This arrangement facilitates the formation of the plated layer 34 in the case where the plated layer 34 is provided without the base electrode layer 32.

In the case where the third dummy electrode 25c and the fourth dummy electrode 25d are provided on the same or substantially the same plane as the first internal electrode layer 16a, it is possible to arrange the third dummy electrode 25c and the fourth dummy electrode 25d on the same or substantially the same plane as the first internal electrode layer 16a by printing the third dummy electrode 25c and the fourth dummy electrode 25d together with the second internal electrode layer 16b when printing the first internal electrode layer 16a.

In the multilayer ceramic capacitor 10A shown in FIGS. 16 to 19, the first dummy electrode 25a, the second dummy electrode 25b, the third dummy electrode 25c, and the fourth dummy electrode 25d are provided at the lateral portions (W-gaps) 22a and 22b and the end portions (L-gaps) 24a and 24b of the multilayer body 12A. Therefore, it is possible to reduce or prevent distortion during pressing.

### (2) Second Modified Example

A multilayer ceramic capacitor 10B according to a second modified example of an example embodiment of the present invention differs from the multilayer ceramic capacitor 10 of the present example embodiment only in the configuration of the multilayer body 12B of the multilayer ceramic capacitor 10B. Therefore, the same or corresponding components to those of the multilayer ceramic capacitor 10 are designated with the same reference numerals, and detailed description thereof is omitted.

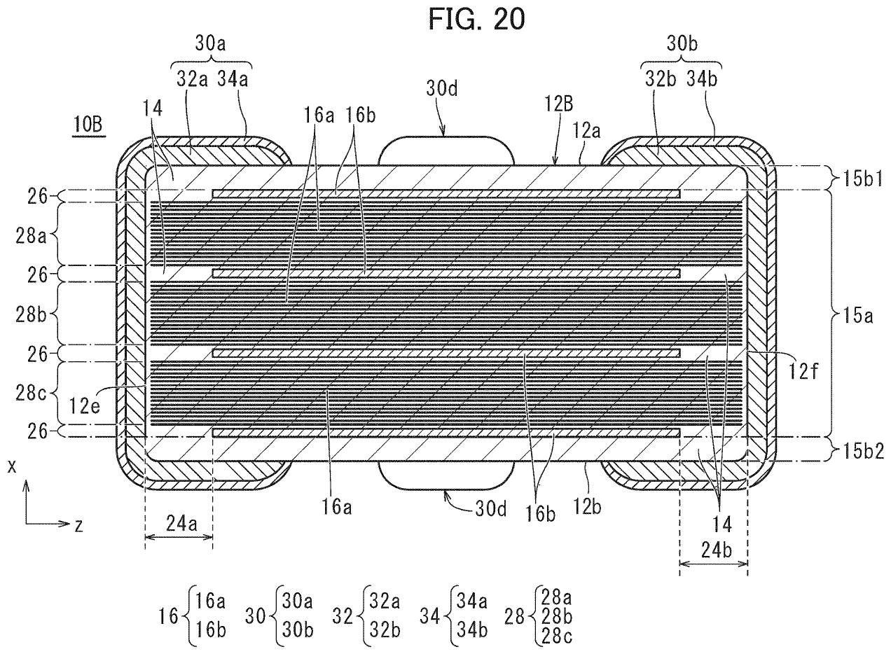

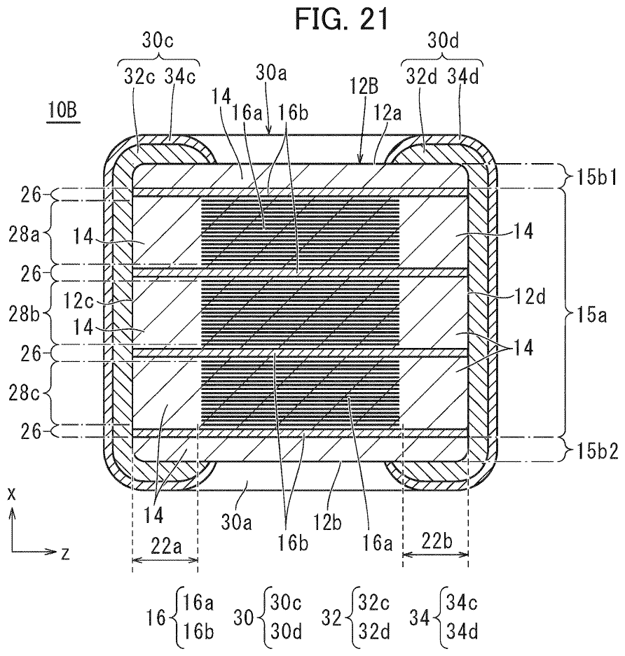

FIG. 20 is a cross-sectional view showing a second modified example of a multilayer ceramic capacitor according to an example embodiment of the present invention, and corresponds to the cross-sectional view of FIG. 6. FIG. 21 is a cross-sectional view showing a second modified example of the multilayer ceramic capacitor according to the present example embodiment of the present invention, and corresponds to the cross-sectional view of FIG. 7.

The multilayer body 12B includes a plurality of dielectric layers 14 that are laminated. Further, the multilayer body 12B includes a first main surface 12a and a second main surface 12b on opposite sides in the lamination direction x, a first lateral surface 12c and a second lateral surface 12d on opposite sides in a width direction y orthogonal or substantially orthogonal to the lamination direction x, and a first end surface 12e and a second end surface 12f on opposite sides in a length direction z orthogonal or substantially orthogonal to both of the lamination direction x and the width direction y.

The multilayer body 12B includes an inner layer portion 15a, and a first outer layer portion 15b1 and a second outer layer portion 15b2 that sandwich the inner layer portion 15a in the lamination direction x.

The dielectric layer 14 of the inner layer portion 15a may be sandwiched between the first internal electrode layers 16a and 16a. In this case, the first internal electrode layers 16a and 16a are continuously provided via the dielectric layer 14 of the inner layer portion 15a.

The dielectric layer 14 of the inner layer portion 15a may also be sandwiched between the second internal electrode layers 16b and 16b. In this case, the second internal electrode layers 16b and 16b are continuously provided via the dielectric layer 14 of the inner layer portion 15a. The dielectric layer 14 of the inner layer portion 15a includes dielectric ceramic particles with a perovskite configuration and including, as a main component, a perovskite compound including, for example, Ba and Ti. At least one of, for example, Si, Mg, Ba, or Mn may be added as an additive to the main component. The additive exists between the ceramic particles.

The inner layer portion 15a of the multilayer body 12B includes a capacitance forming portion 26 in which the first internal electrode layer 16a and the second internal electrode layer 16b are opposed to each other via the dielectric layer 14 to generate electrostatic capacitance, and an internal electrode lamination portion 28 which is a region where two or more first internal electrode layers 16a are laminated continuously. The multilayer ceramic capacitor 10B has the capacitor characteristics due to the capacitance forming portion 26.

The internal electrode lamination portion 28 is arranged so as to be divided into a plurality of internal electrode lamination portions 28 by the second internal electrode layer 16b. With such a configuration, the aggregate of the first internal electrode layers 16a is dispersed, thus improving heat dissipation, and it is possible to reduce or prevent temperature rise.

As shown in FIGS. 20 and 21, in the multilayer ceramic capacitor 10B, the internal electrode lamination portion 28 is divided by two second internal electrode layers 16b, and the internal electrode lamination portion 28 is divided into a first internal electrode lamination portion 28a, a second internal electrode lamination portion 28b, and a third internal electrode lamination portion 28c.

The second internal electrode layer 16b provided to divide the internal electrode lamination portion 28, which is a region where two or more of the first internal electrode layers 16a are continuously laminated, may be provided as a single layer. With such a configuration, it is possible to laminate a greater number of the first internal electrode layers 16a, thus achieving a reduction in direct current resistance.

The second internal electrode layer 16b arranged to divide the internal electrode lamination portion 28, which is a region where two or more first internal electrode layers 16a are laminated continuously, may be arranged as two or more layers laminated continuously. With such a configuration, even if the number of the second internal electrode layers 16b is reduced, it is possible to achieve better connectivity between the second internal electrode layers 16b and the external electrode 30.

The second internal electrode layer 16b may be provided in the internal electrode lamination portion 28, which is a region where two or more of the first internal electrode layers 16a located on the first main surface 12a side of the multilayer body 12B are continuously laminated, namely, between the first internal electrode lamination portion 28a and the first main surface 12a and the internal electrode lamination portion 28, which is a region where two or more of the first internal electrode layers 16a located on the second main surface 12b side of the multilayer body 12B are continuously laminated, namely, between the third internal electrode lamination portion 28c and the second main surface 12b. With such a configuration, since the capacitance forming portion 26 can also be provided near the first outer layer portion 15b1 and the second outer layer portion 15b2, a portion of the electrostatic capacitance is obtained, and it is possible to shorten the current path to the mounting board and achieve the advantageous effect of low ESL.

The second internal electrode layer 16b may not necessarily be provided in the internal electrode lamination portion 28, which is a region where two or more of the first internal electrode layers 16a located on the first main surface 12a side of the multilayer body 12B are continuously laminated, namely, between the first internal electrode lamination portion 28a and the first main surface 12a, and the internal electrode lamination portion 28, which is a region where two or more of the first internal electrode layers 16a located on the second main surface 12b side of the multilayer body 12B are continuously laminated, namely, between the third internal electrode lamination portion 28c and the second main surface 12b. With such a configuration, the distance from the surface of the multilayer body 12B to the capacitance forming portion 26, where the electrostatic capacitance is formed, becomes greater, and it is possible to achieve the advantageous effect that even if a crack occurs from the surface of the multilayer body 12B due to an external load, degradation of insulation resistance is less likely to occur.

The thickness of the dielectric layer 14 adjacent to the second internal electrode layer 16b is preferably greater than the thickness of the dielectric layer 14 sandwiched between the first internal electrode layers 16a. With such a configuration, it is possible to laminate a greater number of the first internal electrode layers 16a, and it is possible to further improve the advantageous effect of reducing direct current resistance.

The thickness of the second internal electrode layer 16b is preferably greater than the thickness of the first internal electrode layer 16a. With such a configuration, even in a case of further reduced capacitance, connectivity can be ensured between the third extension electrode portion 20c of the second internal electrode layer 16b and the first lateral surface external electrode 30c provided on the first lateral surface 12c, and it is possible to improve the connectivity between the fourth extension electrode portion 20d of the second internal electrode layer 16b and the second lateral surface external electrode 30d provided on the second lateral surface 12d.

As described above, example embodiments of the present invention are disclosed by the above-described description, but the present invention is not limited thereto. That is, it is possible to make various modifications to the above-described example embodiments in terms of mechanism, shape, material, quantity, position, arrangement, and the like without departing from the technical concept and the scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component, comprising:
a multilayer ceramic capacitor; and
a conductor portion; wherein
the multilayer ceramic capacitor includes:
a multilayer body including a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to both of the lamination direction and the width direction;
a first end surface external electrode wrapping around from the first end surface to the first main surface and the second main surface of the multilayer body;
a second end surface external electrode wrapping around from the second end surface to the first main surface and the second main surface of the multilayer body;
a first lateral surface external electrode on the first lateral surface of the multilayer body; and
a second lateral surface external electrode on the second lateral surface of the multilayer body;
the conductor portion is electrically connected to the first end surface external electrode and the second end surface external electrode;
the conductor portion includes:
a first connection region on one of surfaces of the conductor portion opposed to each other in the lamination direction, the one of the surfaces being on a multilayer ceramic capacitor side, and the first connection region being located on a first end surface side; and
a second connection region on the one of the surfaces of the conductor portion opposed to each other in the lamination direction, the one of the surfaces being on the multilayer ceramic capacitor side, the second connection region being located on a second end surface side;
a tip of the first connection region on a center side in the length direction of the multilayer ceramic capacitor is located closer to the first end surface side than a tip of the first end surface external electrode on a center side in the length direction, the first end surface external electrode being provided on the first main surface, and the first connection region is connected to the first end surface external electrode by an electrically conductive adhesive; and
a direct current resistance of the conductor portion is smaller than a direct current resistance of the multilayer ceramic capacitor.

2. The multilayer ceramic electronic component according to claim 1, wherein a tip of the second connection region on a center side in the length direction of the multilayer ceramic capacitor is located closer to the second end surface side than a tip of the second end surface external electrode on a center side in the length direction, the second end surface external electrode being provided on the first main surface, and the second connection region is connected to the second end surface external electrode by an electrically conductive adhesive.

3. The multilayer ceramic electronic component according to claim 1, wherein
the multilayer body includes:
a first internal electrode layer including one end exposed at the first end surface and the second end surface; and
a second internal electrode layer including one end exposed at the first lateral surface and the second lateral surface.

4. The multilayer ceramic electronic component according to claim 1, wherein the electrically conductive adhesive includes solder.

5. The multilayer ceramic electronic component according to claim 1, wherein the conductor portion includes an insulating board and an electrically conductive pattern on one main surface of the insulating board.

6. The multilayer ceramic electronic component according to claim 5, wherein a protective layer is provided on a surface of the electrically conductive pattern.

7. The multilayer ceramic electronic component according to claim 1, wherein the conductor portion includes an insulating board, a first electrically conductive pattern on one main surface of the insulating board, and a second electrically conductive pattern on another main surface of the insulating board.

8. The multilayer ceramic electronic component according to claim 7, wherein a protective layer is provided on a surface of the first electrically conductive pattern.

9. The multilayer ceramic electronic component according to claim 1, wherein the conductor portion includes a plurality of insulating boards, and electrically conductive patterns between the plurality of insulating boards.

10. The multilayer ceramic electronic component according to claim 9, wherein a protective layer is provided on a portion of a main surface of one of the plurality of insulating boards.

11. A mounting configuration of a multilayer ceramic electronic component, the mounting configuration comprising:
the multilayer ceramic electronic component according to claim 1; and
a mounting board on which the multilayer ceramic electronic component is mounted; wherein
the multilayer ceramic electronic component is mounted such that the conductor portion does not face the mounting board.

12. The mounting configuration according to claim 11, wherein a tip of the second connection region on a center side in the length direction of the multilayer ceramic capacitor is located closer to the second end surface side than a tip of the second end surface external electrode on a center side in the length direction, the second end surface external electrode being provided on the first main surface, and the second connection region is connected to the second end surface external electrode by an electrically conductive adhesive.

13. The mounting configuration according to claim 11, wherein
the multilayer body includes:
a first internal electrode layer including one end exposed at the first end surface and the second end surface; and
a second internal electrode layer including one end exposed at the first lateral surface and the second lateral surface.

14. The mounting configuration according to claim 11, wherein the electrically conductive adhesive includes solder.

15. The mounting configuration according to claim 11, wherein the conductor portion includes an insulating board and an electrically conductive pattern on one main surface of the insulating board.

16. The mounting configuration according to claim 15, wherein a protective layer is provided on a surface of the electrically conductive pattern.

17. The mounting configuration according to claim 11, wherein the conductor portion includes an insulating board, a first electrically conductive pattern on one main surface of the insulating board, and a second electrically conductive pattern on another main surface of the insulating board.

18. The mounting configuration according to claim 17, wherein a protective layer is provided on a surface of the first electrically conductive pattern.

19. The mounting configuration according to claim 11, wherein the conductor portion includes a plurality of insulating boards, and electrically conductive patterns between the plurality of insulating boards.

20. The mounting configuration according to claim 19, wherein a protective layer is provided on a portion of a main surface of one of the plurality of insulating boards.
